(19) United States
(12) Patent Application Publication
(10) Pub. No.: US 2025/0337459 A1
(43) Pub. Date: Oct. 30, 2025

(54) CONTROL INFORMATION AND TCI FOR RECONFIGURABLE INTELLIGENT SURFACES

(71) Applicant: InterDigital Patent Holdings, Inc., Wilmington, DE (US)

(72) Inventors: Kyle Jung-Lin Pan, Saint James, NY (US); Tezcan Cogalan, London (GB); Patrick Svedman, Stockholm (SE); Arman Shojaeifard, London (GB); Allan Yingming Tsai, Boonton, NJ (US); Deepa Gurmukhdas Jagyasi, London (GB)

(73) Assignee: InterDigital Patent Holdings, Inc., Wilmington, DE (US)

(21) Appl. No.: 18/859,683

(22) PCT Filed: Apr. 27, 2023
(86) PCT No.: PCT/US2023/020128

§ 371 Date: Oct. 24, 2024

Related U.S. Application Data
(60) Provisional application No. 63/336,063, filed on Apr. 28, 2022.

(51) Int. Cl. H04B 7/04; H04W 24/08; H04W 72/23

(52) U.S. Cl. CPC H04B 7/04013; H04W 24/08; H04W 72/23

(57) ABSTRACT

Control information and transmission configuration indicator (TCI) are provided for reconfigurable intelligent surfaces (RISs). A wireless transmit/receive unit (WTRU) may receive a first physical downlink shared channel (PDSCH) transmission using a first TCI state associated with a base station and using a second TCI state associated with a first RIS mode. The WTRU may perform a reference signal measurement associated with an RIS. The WTRU may determine an interference level based on the reference signal measurement. The WTRU may determine a second RIS mode based on the interference level. The WTRU may send a message to the base station, wherein the message indicates the second RIS mode. The WTRU may receive an indication of a third RIS mode associated with a third TCI state associated with the base station. The WTRU may receive a second PDSCH transmission using the third TCI state.

### CROSS-REFERENCE TO RELATED APPLICATIONS

This application is the National Stage Entry under 35 U.S.C. § 371 of Patent Cooperation Treaty Application No. PCT/US2023/020128, filed Apr. 27, 2023 which claims the benefit of U.S. Provisional Patent Application No. 63/336,063, filed Apr. 28, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for control information and transmission configuration indicator (TCI) for reconfigurable intelligent surfaces (RISs).

A device (e.g., a wireless transmit/receive unit (WTRU)) may receive a first physical downlink shared channel (PDSCH) transmission using a first transmission configuration indicator (TCI) state associated with a base station and using a second TCI state associated with a first reconfigurable intelligent surface (RIS) mode. The device may perform a reference signal measurement associated with an RIS. The device may determine an interference level based on the reference signal measurement. The device may determine a second RIS mode based on the interference level. The device may send a message to the base station. The message may indicate the second RIS mode. The device may receive an indication of a third RIS mode associated with a third TCI state. The third TCI state may be associated with the base station. The device may receive a second PDSCH transmission using the third TCI state.

On a condition that the interference level is greater than an interference threshold, the second RIS mode may be determined to be an absorption mode. On a condition that the third RIS mode indicates an absorption mode, the device may deactivate the second TCI state associated with the first RIS mode. The message may indicate at least one of: the reference signal measurement, or the interference level. The third RIS mode may be different from the second RIS mode. The device may activate the third TCI state based on the indication of the third RIS mode. The device may receive configuration information. The configuration information may indicate a plurality of TCI states and respective associations with RIS operation modes. The indication of the third RIS mode may be received in a group common physical downlink control channel (GC-PDCCH) transmission.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a reconfigurable intelligent surface system.

FIG. 3 illustrates an example of a reconfigurable intelligent surface (RIS) configured as a reflecting RIS based on an RIS operation mode for beam reflection only.

FIG. 4 illustrates an example of a RIS configured as a reflecting and transmitting RIS based on an RIS operation mode for simultaneous reflecting and transmitting.

FIG. 5 illustrates an example of TCI configurations for a RIS configured for simultaneous reflecting and transmitting.

FIG. 6 illustrates an example method for a hybrid RIS TCI configuration for RIS types and RIS operation modes.

FIG. 7 illustrates an example method of hybrid RISs for multi-RIS with an RIS mode switch and TCI reconfiguration.

FIG. 8 illustrates an example method of TCI activation and deactivation for an RIS.

FIG. 9 illustrates an example method of RIS operations for RIS-based or RIS-aided systems.

FIG. 10 illustrates an example method of TCI activation and deactivation for RIS-aided systems.

FIG. 11 illustrates an example method of indicating and updating a TCI for an RIS-aided system.

FIG. 12 illustrates an example method of TCI indication and update for an RIS-aided system.

FIG. 13 illustrates an example method of TCI indication and update for an RIS-aided system (e.g., with simultaneous reflecting and transmitting).

FIG. 14 illustrates an example method of a PDSCH reception at a WTRU for an RIS type and an RIS mode based on the WTRU's feedback.

FIG. 15 illustrates an example method of RIS mode switch and TCI indication.

FIG. 16 illustrates an example method of RIS ON-OFF information for efficient interference management.

FIG. 17 illustrates an example method of RIS on/off indication via a group RNTI.

FIG. 18 illustrates an example method of RIS mode switch and TCI indication based on an interference level.

FIG. 19 illustrates an example method of UL/DL TDD configuration for an RIS.

FIG. 20 illustrates an example of timing advance offset alignment for an RIS-aided system.

FIG. 21 illustrates an example method of timing information to align transmission and reception boundaries for an RIS.

### EXAMPLE NETWORKS FOR IMPLEMENTATION OF THE EMBODIMENTS

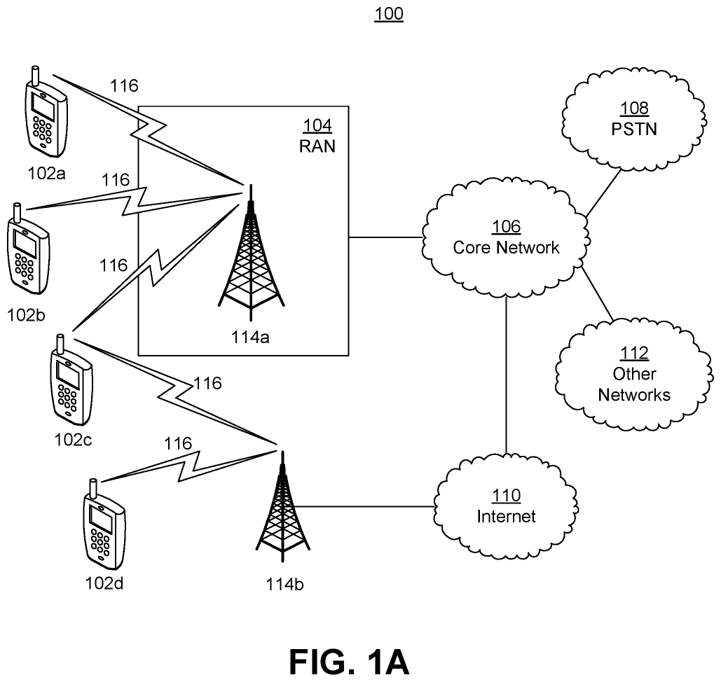

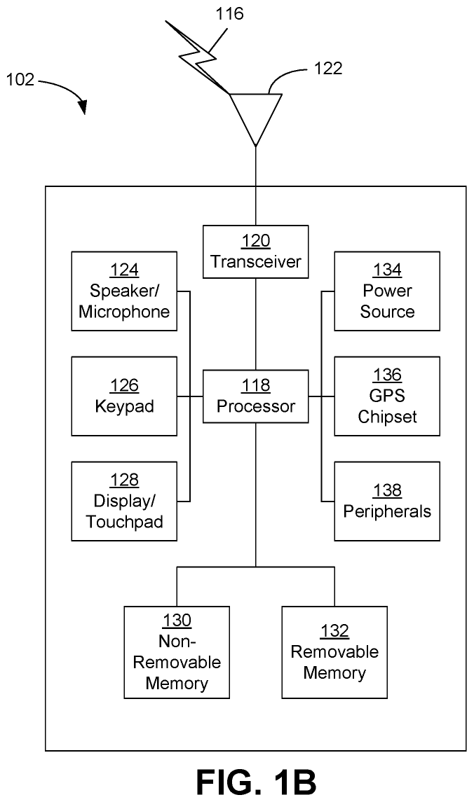

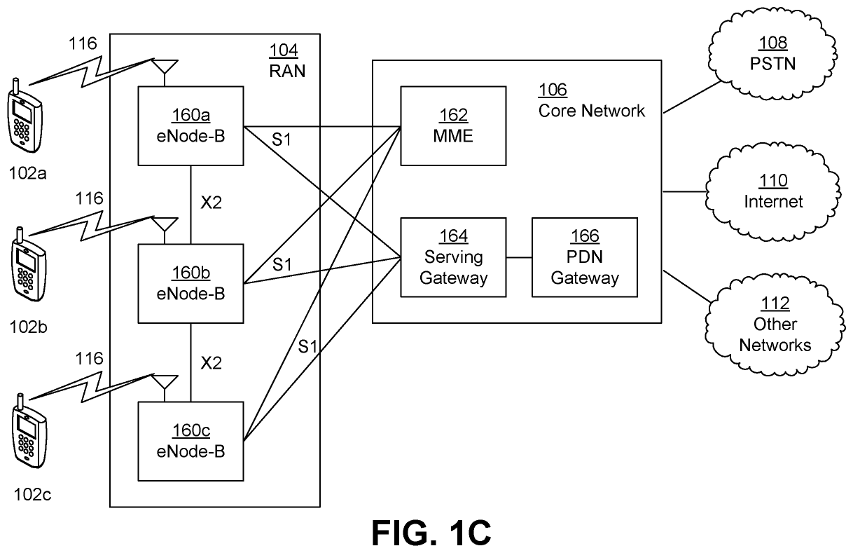

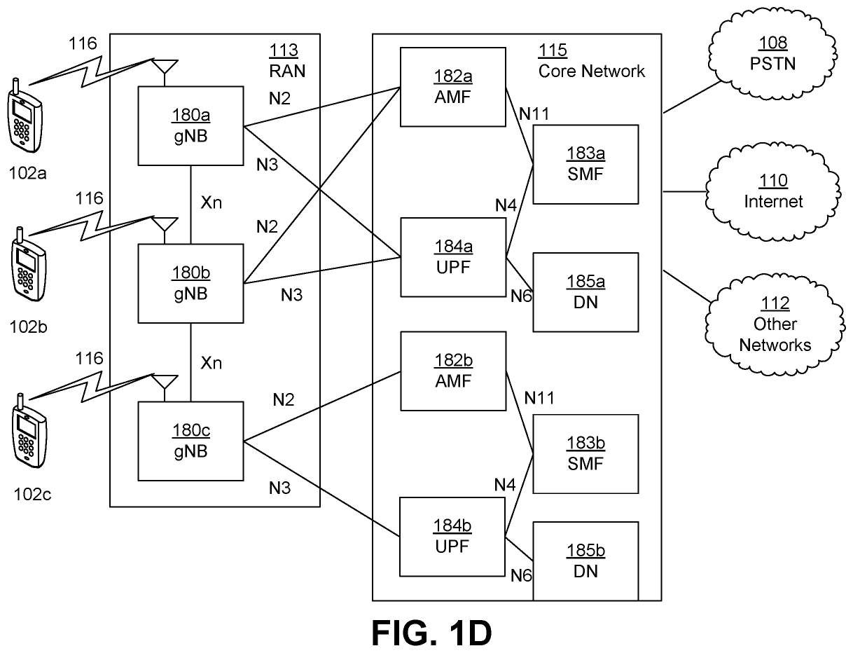

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may perform reception (e.g., physical downlink control channel (PDCCH)/physical downlink shared channel (PDSCH) reception) and/or transmission (e.g., physical uplink control channel (PUCCH)/physical uplink shared channel (PUSCH) transmission), for example, via a reconfigurable intelligent surface (RIS) for an RIS-aided system (e.g., based on an RIS type and/or an RIS operation mode). A WTRU may be configured with reference signal (RS) resources, for example, according to an RIS type and/or an RIS operation mode.

A WTRU may perform, for example, one or more of the following: receive configuration information with one or more transmission configuration indicator (TCI) states and/or an association with an RIS (e.g., based on an RIS type and/or an RIS operation mode); activate TCI state(s) for beamforming information in an RIS-aided system; receive a TCI indication for beam information for reception or transmission via the RIS; decode a PDCCH with an RIS radio network temporary identifier (RIS-RNTI) and/or a group common PDCCH (GC-PDCCH) with an RIS-GC-RNTI; indicate an RIS operation mode change or switch; switch a TCI state indicated in a TCI, for example, based on a new RIS operation mode TCI that may be indicated, for example, together with the mode indication (e.g., TCI may not be updated, for example, if RIS mode is not changed); deactivate one or more TCI states for beamforming information corresponding to absorption operation (e.g., based on RIS absorption mode), for example, if RIS operation mode is absorption mode; receive PDCCH and/or PDSCH via one or more RIS beam(s) using a new indicated TCI for downlink (DL) for the new RIS mode; transmit PUCCH and/or PUSCH via one or more RIS beam(s) using a new indicated TCI for uplink (UL) for the new RIS mode; and/or receive PDCCH and/or PDSCH via one or more RIS beam(s) using existing TCI for DL or transmit PUCCH and/or PUSCH via one or more RIS beam(s) using existing TCI for UL for an existing RIS mode, for example, if RIS mode is not changed.

The RIS may be turned on or off or activated or deactivated for an RIS-aided system. A WTRU may be configured and/or associated with one or more RIS(s) for an RIS-aided system.

A WTRU may measure interference on primary RS resources for a gNB/transmission-reception point (TRP) in an RIS-aided system (e.g., may perform a reference signal measurement associated with a base station and determine an interference level based on the reference signal measurement). The WTRU may measure interference on secondary RS resources for associated RIS(s) in the RIS-aided system (e.g., may perform a reference signal measurement associated with an RIS and determine an interference level(s) based on the reference signal measurement). The WTRU may transmit the interference measurement(s) (e.g., interference level) to the gNB/TRP. The WTRU may transmit a recommended RIS operation mode to the gNB/TRP (e.g., may send a message to a base station, where the message indicates the recommended RIS operation mode). The WTRU may transmit the recommended RIS operation mode together with the interference measurement(s) (e.g., interference level(s)) for the RIS(s) to the gNB/TRP (e.g., the message sent to the base station may indicate the interference level(s)). For example, the recommended RIS operation mode may be based on a first (pre) configured threshold. For example, the WTRU may determine an interference level based on the reference signal measurement and determine the recommended RIS operation mode based on the interference level. For example, on a condition that the interference level is greater than the first (pre) configured threshold (e.g., an interference threshold), the recommended RIS operation mode may be an absorption mode. The WTRU may transmit, to the gNB/TRP, a recommendation to turn the RIS on or off; and/or transmit, to the gNB/TRP, the recommendation to turn the RIS on or off, together with the interference measurement(s) for RIS(s) (e.g., the recommendation to turn the RIS on/off may be based on a second (pre) configured threshold).

A gNB/TRP may perform, for example, one or more of the following: receive WTRU feedback; determine an RIS to be turned on or off (e.g., based on WTRU feedback); determine an RIS to be activated or deactivated (e.g., based on WTRU feedback); determine whether to switch an RIS operation mode and which mode to switch to (e.g., based on WTRU feedback, for example, the WTRU feedback may be a recommended RIS operation mode and/or an interference measurement; WTRU feedback may be carried in a PUCCH and/or a PUSCH periodically, semi-periodically, and/or aperiodically); and/or indicate an RIS to be turned on/off (e.g., an indication may be carried in a GC-PDCCH, a MAC CE or RRC signaling, where the container to use may depend on payload size).

An RIS may perform, for example, one or more of the following: receive configuration information for an RIS-RNTI or an RIS-GC-RNTI; receive an indication from a gNB/TRP to turn the RIS on/off (e.g., via a PDCCH with RIS-RNTI or a GC-PDCCH with RIS-GC-RNTI); receive an indication from gNB/TRP for activating/deactivating the RIS; receive a GC-PDCCH, for example, if the payload size is small and/or if fast on/off is required; receive a MAC CE or RRC, for example, if the payload size is large and/or if fast on/off is not required; turn the RIS on/off based on the received indication; and/or activate/deactivate the RIS based on the received indication.

A TCI framework may be implemented. A unified TCI may support a (e.g., single) TRP. A non-unified TCI may support, for example, operation of multiple (e.g., up to two) TRP operations (e.g., without support of a coherent joint transmission among TRPs). A non-unified TCI may support an indication of multiple (e.g., up to two) TCI states with a (e.g., one) TCI code point. TCI may support a frequency range for FR1 and/or FR2.

Multi-TRP operation may support one or more of the following: dynamic TRP selection, and/or mobility measurements for multi-beam/multi-TRP deployments (e.g., up to 64 synchronization signal blocks (SSBs) per cell), transmission of PDSCH for enhanced mobile broadband (eMBB), multi-TRP diversity for ultra-reliable and low latency communications (URLLC), multi-TRP operation based on one or more (e.g., two) TRPs, inter-cell multi-TRP operation (e.g., without handover), and/or multi-TRP repetition of PDCCH, PUCCH, and/or PUSCH.

A channel state information reference signal (CSI-RS) framework may be implemented. A CSI interference measurement may be based on zero power CSI-RS (ZP-CSI-RS) and/or non-zero power CSI-RS (NZP-CSI-RS) resources. CSI-RS operation may support a Type-Il codebook for high-resolution CSI feedback, and/or CSI enhancement for multi-TRP non-coherent joint transmission (NCJT), etc.

A reconfigurable intelligent surface (RIS) corresponds to a type of network node that uses smart radio surfaces of many small antennas or metamaterial elements that enable control of the propagation environment through tunable scatterings of electromagnetic (EM) waves. The surfaces may have reflection, refraction, and absorption properties that can be reconfigured and adapted to specific radio channel environments using a microcontroller (e.g., field-programmable gate array (FPGA)). Configuration of an RIS may be handled or assisted by the network through a (e.g., separate) control signaling link for exchanging (e.g., relevant) side control information.

RISs may support implementation of smart and reconfigurable wireless environments for wireless communication systems. An RIS may be a planar surface with a (e.g., large) number of elements. An (e.g., each) element may (e.g., be able to independently) induce a controllable amplitude and/or phase change to the incident signal. Dense deployment of RISs in wireless network may support flexible reconfiguration of wireless channels between transmitters and receivers, for example, to achieve desired realizations and distributions, which may reduce wireless channel fading and interference and/or improve wireless communication capacity and reliability. RIS may create virtual line-of-sight (LOS) links (e.g., to bypass obstacles via smart reflection). RIS may add signal paths toward desired directions, which may improve channel rank, refine channel statistics and/or distribution, and/or suppress or null interference.

RIS (e.g., in contrast to active antenna arrays) may be integrated into existing wireless systems (e.g., cellular network systems). RIS may be (e.g., massively) deployed in wireless networks, for example, to significantly (e.g., and cost-effectively) enhance spectral and energy efficiency. RIS implementation may modify wireless system/network designs, for example, from multiple input multiple output (MIMO) systems without RIS to RIS-aided MIMO systems. RISs may be more densely deployed in wireless networks at a lower cost than other wireless communication technologies.

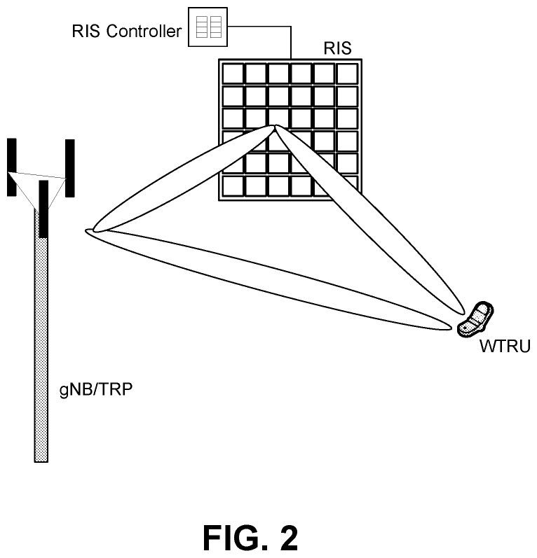

FIG. 2 illustrates an example of a reconfigurable intelligent surface system.

RIS-aided network deployments may be based on use cases and deployment considerations. Example RIS-integrated system deployments may include, for example, RIS-based massive MIMO and/or RIS-based coverage enhancement. In an example of an RIS-based massive MIMO system, RISs may be deployed (e.g., alongside) a gNB/TRP to improve spectral efficiency. In an example of an RIS-based coverage enhancement, RISs may be deployed away from gNBs/TRPs to enhance coverage for weak coverage areas and/or coverage holes (e.g., due to obstructions for line-of-sight links between gNBs/TRPs and WTRUs) and/or to extend coverage areas for gNBs/TRPs.

Control information (e.g., including side control information), beamforming related signaling, TCI indications, control information for beamforming and beam management, configurations, quasi-colocation (QCL), etc., may be based on the assumptions of a transmitter (Tx) and receiver (Rx) beam pair without the presence of one or more reconfigurable intelligent surfaces (RIS) nodes. Communication-related procedures may be impacted in an RIS-integrated system. Side control information may enable (e.g., integrated) RISs to operate efficiently and/or effectively. Mechanisms for exchanging control information (e.g., including side control information) may be implemented for an RIS-integrated system, such as beamforming information, on/off information, UL/DL time domain duplexing (TDD) configuration information, TCI configuration, activation, indication, interference management and associated signaling, reference signal and related procedures, etc. RISs may impact control information and signaling implementations and/or TCI operations. UL/DL TDD slots may be configured for RIS and WTRUs that have a link to a gNB via an RIS. Timing advance offset values may be aligned for WTRUs that have a link to a gNB via an RIS, for example, to receive UL signals (e.g., simultaneously) at the gNB and the RIS.

TCI may be configured and reconfigured for RIS-based or RIS-aided systems. A WTRU may be configured and/or reconfigured with TCI states, for example, based on RIS types of the RIS(s) that serve the WTRU. An RIS that serves a WTRU may aid a communication link with the WTRU (e.g., an RIS operating in a serving cell of the WTRU). An RIS may be passive, semi-active, hybrid, or active. A passive RIS may refer to implementations without reflection amplifiers for (e.g., all) unit-cells (e.g., or antenna elements). A hybrid or semi-active RIS may correspond to an RIS with one or more unit-cells that utilize reflection amplifiers, which may provide control in amplitude response. An active RIS may refer to (e.g., all) unit-cells having reflection amplifiers.

A WTRU may be configured and/or reconfigured with TCI states, for example, based on an RIS type and/or an RIS operation mode of the RIS(s) that serve(s) the WTRU. RIS operation (e.g., in terms of impact on impinging RF signals) may include, for example, one or more (e.g., any combination) of the following: reflection, refraction, focusing, collimation, absorption, and/or focus. An RIS may have different types, different operation modes, different functionalities, etc. For example, an RIS may be a passive, semi-active, hybrid, or active type RIS.

A TCI state may be based on RIS types and/or RIS operation modes. A TCI state may be for one RS resource (e.g., corresponding to one beam) or multiple RS resources (e.g., corresponding to multiple beams). An RS resource may be a resource for CSI-RS, TRS, SSB, and/or the like. For example, an RIS may be capable of reflecting multiple beams simultaneously. An RIS may be made of an (e.g., a large) array of passive scattering elements, which may be referred to as unit cells. A (e.g., each) unit cell may be configured (e.g., by the network) to achieve one or more of desired signal reflections, refractions, focusing, collimation, absorption, etc.

TCI states may be configured or reconfigured (or activated or deactivated) for different RIS operation modes (e.g., configuration information may indicate that the TCI states and respective associations with RIS operation modes). RIS operation modes may include, for example, reflecting RIS, transmitting RIS, receiving RIS, simultaneously transmitting and reflecting RIS, simultaneously reflecting and sensing RIS, amplifying RIS, etc. For example, a simultaneously transmitting and reflecting RIS (e.g., operation mode) may enable a reconfigurable wireless environment with 360-degree coverage. A simultaneously reflecting and sensing RIS may simultaneously reflect the impinging signal (e.g., in a programmable way) while (e.g., at the same time, simultaneously, concurrently) the impinging signal may be fed to a sensing unit.

CSI-RS resources may be associated with an RIS. CSI-RS resources may be configured and/or used for reflecting beams at an RIS. CSI-RS resources associated with an RIS may be used for transmitting beams at an RIS (e.g., if the RIS is capable of transmitting beams). CSI-RS resources associated with an RIS may be used for simultaneously transmitting and reflecting beams at an RIS (e.g., if the RIS is capable of simultaneously reflecting beams and transmitting beams). There may be multiple (e.g., two) beams arising from a single beam (e.g., between a gNB and an RIS). The resulting/arising beams may be referred to as a reflective beam and a transmitting beam (e.g., between the RIS and a WTRU). A first WTRU may measure a CSI-RS and report the beam (e.g., the layer one reference signal received power (L1-RSRP) for the CSI-RS resource). A second WTRU may (e.g., also) measure the same CSI-RS and report the same beam. A gNB may configure the WTRUs with the same TCI state. A gNB may activate the TCI state (e.g., if/when needed). The gNB may indicate the TCI state for a WTRU to receive a PDSCH, for example, if/when the gNB transmits data to the WTRU. A gNB may (e.g., also) transmit data to another (e.g., the second) WTRU. The gNB may indicate the TCI state for the other (e.g., second) WTRU to (e.g., also) receive a PDSCH. The gNB may assign different frequency resources for the different WTRUs to receive the PDSCH using the same TCI state for reflecting beams and transmitting beams.

A (e.g., first) WTRU may measure a (e.g., first) CSI-RS and report the (e.g., first) beam while another (e.g., second) WTRU may measure a different (e.g., second) CSI-RS and report the other (e.g., second) beam. The gNB may configure the (e.g., first and second) WTRUs with different TCI states. The gNB may activate different TCI states (e.g., if/when needed). The gNB may indicate a (e.g., a first) TCI state for the (e.g., first) WTRU to receive a PDSCH, for example, if/when the gNB transmits data to the (e.g., first) WTRU. The gNB may (e.g., also) transmit data to another (e.g., the second) WTRU. The gNB may indicate another (e.g., a second) TCI state for the other (e.g., the second) WTRU to receive a PDSCH. The gNB may assign different frequency resources for the (e.g., first and second) WTRUs to receive the PDSCH using different TCI states for reflecting beams and transmitting beams.

CSI-RS resources associated with a gNB may not be used for an RIS. TCI states associated with an RIS (e.g., operating in absorption mode) may not be configured for a WTRU (e.g., since the beam may not be received by a WTRU). CSI-RS resources associated with an RIS may be used for the RIS, which may operate in a simultaneous reflecting and sensing mode. TCI states may be associated with an RIS and/or may be configured for a WTRU, for example, depending on RIS operation modes.

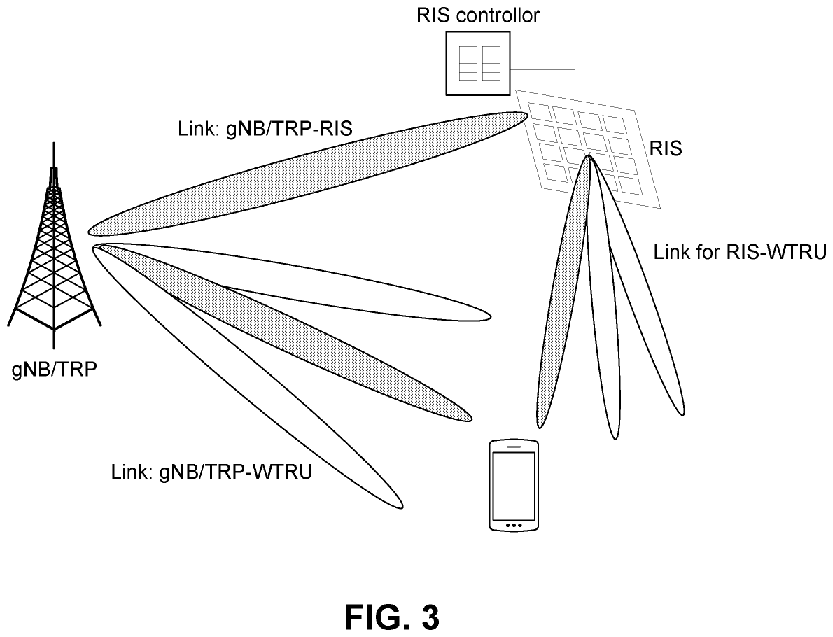

FIG. 3 illustrates an example of a RIS configured as a reflecting RIS based on an RIS operation mode for beam reflection only. A WTRU may be configured with TCI states that are associated with a gNB. A WTRU may be configured with additional TCI states that are associated with an RIS for an operation/operating mode (e.g., reflecting beams only).

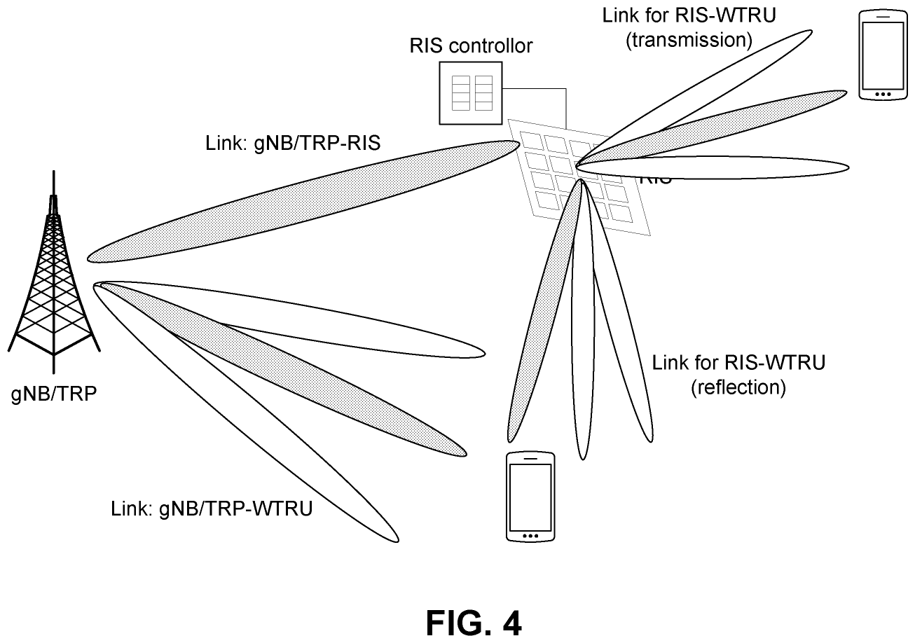

FIG. 4 illustrates an example of a RIS configured as a reflecting and transmitting RIS based on an RIS operation mode for simultaneous reflecting and transmitting. A WTRU may be configured with TCI states that are associated with a gNB. A WTRU may be configured with TCI states that are associated with an RIS for an operation mode with reflecting beams. A WTRU may (e.g., also) be configured with (e.g., additional) TCI states associated with an RIS for an operation mode with transmitting beams, for example, if the RIS is capable of (e.g., and configured for) transmitting beams.

A CSI-RS resource set may be configured for an RIS. A beam may be repeated for a link between a gNB/TRP and an RIS (e.g., a gNB-RIS link), for example, for CSI-RS resources within the CSI-RS resource set. A beam repetition may be indicated to an RIS, for example, so that the RIS is aware that the same beam is repeated over CSI-RS resources within a CSI-RS resource set for the link between the gNB/TRP and the RIS. Beam repetition and/or a repetition indication may be used for beam management or beam sweeping for an RIS-aided system. A repetition indicator for CSI-RS resources may be sent to an RIS to manage a beam for the link between the gNB/TRP and the RIS. A beam may or may not be repeated for a link between an RIS and a WTRU (e.g., an RIS-WTRU link). Beam sweeping may (e.g., instead) be performed for the link between the RIS and the WTRU. The RIS and WTRU may be configured with the same CSI-RS resource set for reflecting beams and transmitting beams, for example, if reflecting beams and transmitting beams are coupled. An RIS may reflect the same beam toward different directions. An RIS may simultaneously transmit the same beam in different directions. Different beams may be reflected and transmitted over CSI-RS resources within the same CSI-RS resource set for the RIS-WTRU link.

Different CSI-RS resource sets for reflecting beams and transmitting beams may be configured to an RIS and a WTRU, for example, if reflecting beams and transmitting beams are not coupled. The same beam may be repeated over CSI-RS resources within a CSI-RS resource set for the gNB-RIS link. Different beams may be reflected and transmitted over CSI-RS resources within different CSI-RS resource sets for the RIS-WTRU link.

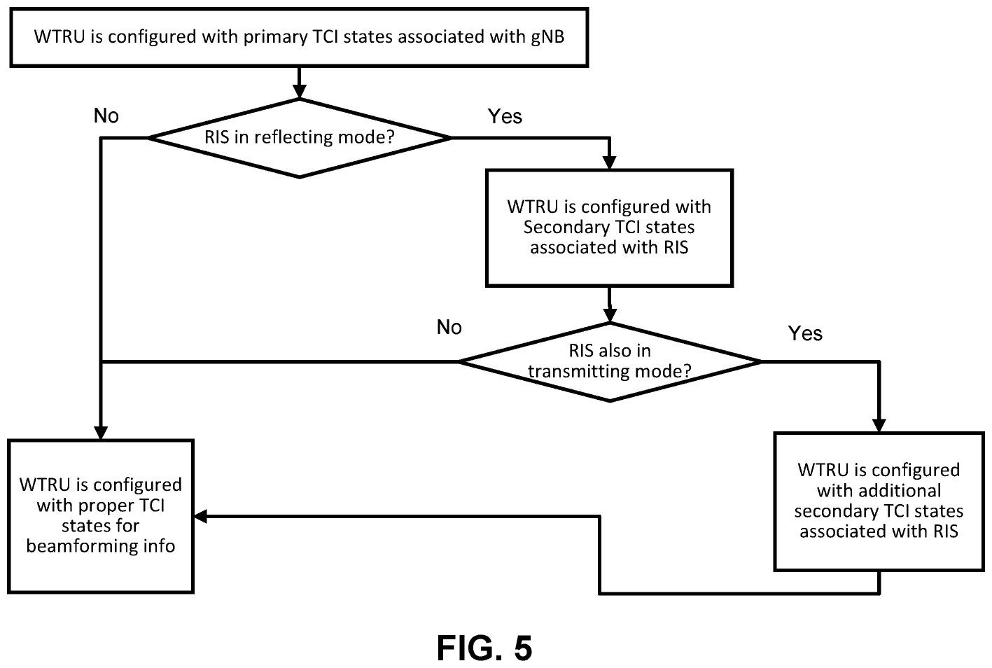

FIG. 5 illustrates an example of TCI configurations for an RIS configured for simultaneous reflecting and transmitting. As shown by example in FIG. 5, a WTRU may be configured with primary TCI states associated with a gNB/TRP. A WTRU may be configured with (e.g., additional/secondary) TCI states associated with an RIS. For example, the WTRU may be configured with additional/secondary TCI states associated with an RIS that performs beam reflection (e.g., if the RIS is operating in a reflecting mode). The WTRU may be configured with additional/secondary TCI states associated with an RIS that performs beam transmission (e.g., if the RIS is operating in transmitting mode).

An association between RIS types and RIS operation modes may be utilized, for example, by a gNB/TRP. Information for association between RIS types and RIS operation modes may be indicated to a WTRU. Some RIS operation modes may be possible (e.g., available) for some RIS types but may not be possible (e.g., may be unavailable) for other RIS types. For example, an RIS operation mode with a reflecting RIS may be used as a passive RIS. For example, an RIS operation mode with an amplifying RIS (e.g., for an entire RIS) may be used as an active RIS, semi-active RIS, or hybrid RIS,. Different RIS operation modes may be associated with the same or different RIS types. Different RIS types may be associated with the same or different RIS operation modes. Some RIS operation modes may be associated with some RIS types while other RIS operation modes may be associated with other RIS types.

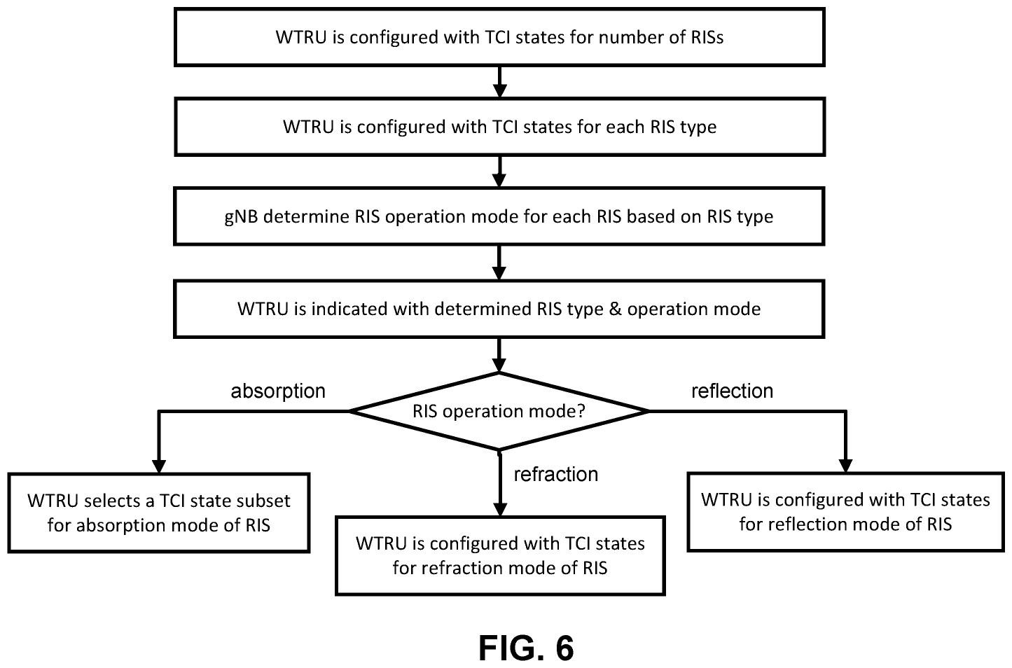

FIG. 6 illustrates an example method for a hybrid RIS TCI configuration for RIS types and RIS operation modes. As illustrated in FIG. 6, a WTRU may be configured with TCI states, for example, based on the number of RISs. For example, a WTRU may be configured with a TCI state for M RISs. M RISs may have the same or different types. A WTRU may be configured with TCI states for a (e.g., each) RIS type. For example, a WTRU may be configured with L; TCI states for each type i. An RIS operation mode may be determined by a gNB, for example, based on an RIS type. A WTRU may receive an indication of an RIS type and/or an RIS mode. A WTRU may be configured or reconfigured for TCI states, for example, depending on an RIS mode. A WTRU may be configured with TCI states for an RIS reflection mode. A WTRU may be configured with TCI states for an RIS refraction mode. A WTRU may select a TCI state subset, for example, based on the indicated RIS type/mode. A WTRU may select a TCI state subset based on the indicated RIS mode, for example, if an RIS absorption mode is determined, indicated, or known.

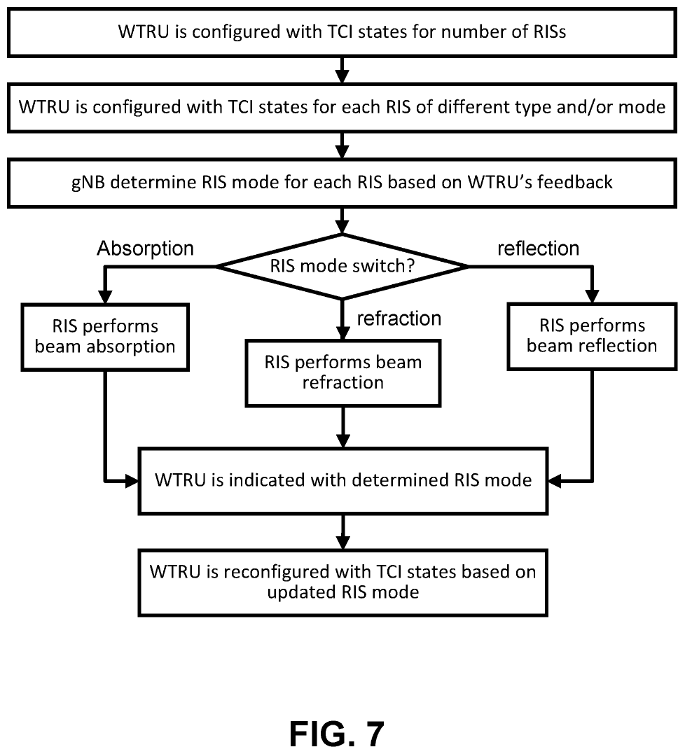

FIG. 7 illustrates an example method of hybrid RISs for multi-RIS with an RIS mode switch and TCI reconfiguration. As illustrated in FIG. 7, a WTRU may be configured with TCI states associated with one or more (e.g., a number of) RISs. Different RISs may have different types and/or different operation modes. For example, a WTRU may be configured with different TCI states associated with each RIS of a different type and/or mode. An RIS mode may be determined, for example, by a gNB based on a WTRU's feedback. A WTRU's feedback may trigger an RIS mode switch. A WTRU's feedback may include, for example, one or more of the following: a WTRU measurement (e.g., a reference signal measurement and/or an interference measurement/level), a WTRU recommended RIS operation mode, a WTRU measured interference level, etc. An RIS may switch to a different RIS mode (e.g., an RIS reflection, refraction, or absorption mode), for example, if a WTRU's feedback triggers an RIS mode switch. The mode switch may depend on the RIS mode that is determined (e.g., based on the WTRU's feedback). A WTRU may receive an indication of the RIS mode to which the RIS has switched or changed. A WTRU may be reconfigured with TCI states based on the determined and changed RIS mode.

An RIS operation mode may be indicated by, for example, a PDCCH, a group common PDCCH (GC-PDCCH), a MAC CE, RRC signaling, etc. An (e.g., each) RIS may be configured with an RNTI (e.g., RIS-RNTI). The same or different RNTIs (e.g., or RIS-RNTIs) may be configured to different RISs. A PDCCH may be masked with an RIS-RNTI, for example, if PDCCH is used. An RIS may decode a PDCCH, for example, with the RIS's own RNTI (e.g., RIS-RNTI). An RIS may obtain the downlink control information (DCI) in a PDCCH for an RIS operation mode indicator, for example, if a CRC test is passed. An RIS operation mode may be updated, changed, or switched (e.g., individually). Table 1 shows an example RIS operation mode indicator. As shown in Table 1, there may be four RIS operation modes (e.g., for reflection, refraction, absorption, and transmission).

An RIS-based group common RNTI may be used, for example, if a GC-PDCCH is used. A group common RNTI may be configured to an RIS. An RIS may decode a GC-PDCCH, for example, with a group common RNTI for RIS (e.g., an RIS-GC-RNTI). An RIS may obtain the DCI in the GC-PDCCH for the RIS operation mode indicator, for example, if a CRC test is passed. RISs (e.g., all RISs) in a group may update, change, or switch their operation mode (e.g., simultaneously).

TABLE 1
Example of an RIS operation mode indicator

| RIS mode indicator | RIS operation mode |
|---|---|
| 00 | reflection |
| 01 | refraction |
| 10 | absorption |
| 11 | transmission |

CSI-RS resources may be configured to a WTRU for a gNB (e.g., a gNB only), an RIS (e.g., an RIS only), both gNB and RIS, etc. A WTRU may be configured with a CSI-RS resource set for beams from a gNB to the WTRU. A WTRU may be configured with additional CSI-RS resource set(s) for beams from an RIS to the WTRU. The CSI-RS resources may not be associated with an RIS, for example, if/when a WTRU is configured with CSI-RS resource set(s) for beams from a gNB to the WTRU. The CSI-RS resources may not be associated with a gNB, for example, if/when a WTRU is configured with additional CSI-RS resource set(s) for beams from an RIS to the WTRU. The CSI-RS resources may be associated with the RIS (e.g., RIS only). An implementation may use RIS-only CSI-RS resources or resource set(s). An implementation may use gNB-only CSI-RS resources or resource set(s). A WTRU may (e.g., be able to) operate in the environment of a gNB with an RIS deployment, for example, by partitioning CSI-RS resources into RIS-only and gNB-only CSI-RS resources. A WTRU may measure beam quality for a gNB/TRP and/or an RIS (e.g., based on an L1-RSRP, L1-SINR, etc.), for example, using gNB/TRP-only CSI-RS resources and/or RIS-only CSI-RS resources. A WTRU may report the CSI-RS resource indicator (CRI) to a gNB/TRP. The WTRU may be configured with CSI-RS resources separately for a gNB/TRP and an RIS, and/or jointly for a gNB/TRP and an RIS. TCI states may be associated with a gNB/TRP and/or an RIS.

A WTRU may be configured with TCI states that are associated with a gNB (e.g., gNB only), for example, to receive a PDSCH from the gNB. The WTRU may be configured with additional TCI states that are associated with an RIS (e.g., RIS only). TCI states that are associated with the gNB (e.g., gNB only) may provide beamforming information for the WTRU to receive a PDSCH from the gNB. TCI states that are associated with the RIS (e.g., RIS only) may provide beamforming information for the WTRU to receive a PDSCH from the RIS.

A WTRU may be configured with TCI states that are associated with a gNB (e.g., gNB only), for example, to receive a PDCCH. The WTRU may be configured with additional TCI states that are associated with an RIS (e.g., RIS only). TCI states that are associated with the gNB (e.g., gNB only) may provide beamforming information for the WTRU to receive a PDCCH from the gNB. TCI states that are associated with the RIS (e.g., RIS only) may provide beamforming information for the WTRU to receive a PDCCH from the RIS.

A WTRU may be configured with TCI states that are associated with a gNB (e.g., gNB only), for example, to transmit a PUSCH. The WTRU may be configured with additional TCI states that are associated with an RIS (e.g., RIS only). TCI states that are associated with the gNB (e.g., gNB only) may provide beamforming information for the WTRU to transmit a PUSCH to the gNB. TCI states that are associated with the RIS (e.g., RIS only) may provide beamforming information for the WTRU to transmit a PUSCH to the RIS.

Similarly, to transmit PUCCH, a WTRU may be configured with TCI states that are associated with a gNB (e.g., gNB only). The WTRU may be configured with additional TCI states that are associated with an RIS (e.g., RIS only). TCI states that are associated with the gNB (e.g., gNB only) may provide beamforming information for WTRU to transmit a PUCCH to the gNB. TCI states that are associated with the RIS (e.g., RIS only) may provide the beamforming information for the WTRU to transmit a PUCCH to the RIS.

TCI may be activated and deactivated for RIS-aided systems. TCI may be activated or deactivated based on RIS operation mode and/or RIS type. TCI activation and deactivation may be implemented for RIS-aided systems with one or more deployed RISs. A network (NW) may configure and/or reconfigure RISs. An RIS may or may not be activated before activating TCI states. A WTRU may monitor RS resources (e.g., CSI-RS resources associated with the RIS), for example, if an RIS is activated. A WTRU may measure a signal reflected or transmitted from an RIS. A WTRU may monitor RS resources (e.g., CSI-RS resources associated with an RIS), for example, if an RIS is not activated. A WTRU may not measure a signal for an inactive RIS, for example, because an inactive RIS may not reflect or transmit a signal. An NW may activate or deactivate (e.g., configured) RISs, for example, based on a need. A WTRU may or may not be configured with TCI states for an (e.g., each) activated RIS. A WTRU may report the most relevant RISs (e.g., the best M RISs) with beam quality above a (pre) configured threshold. The beam quality may be measured, for example, via corresponding RS (e.g., CSI-RS) resources using one or more metrics (e.g., L1-RSRP, L1-SINR, etc.). A WTRU may report the RIS IDs for the most relevant RIS based on the one or more measurements. A WTRU may report an RIS ID via UL signaling or a channel (e.g., a PUCCH, PUSCH, MAC CE, or the like). In some examples, the best beam quality may be the strongest beam RIS or the largest number of beams with a reasonably good quality although not necessarily the strongest beam, etc. An NW may associate a WTRU with one or more RISs, for example, based on the report from the WTRU.

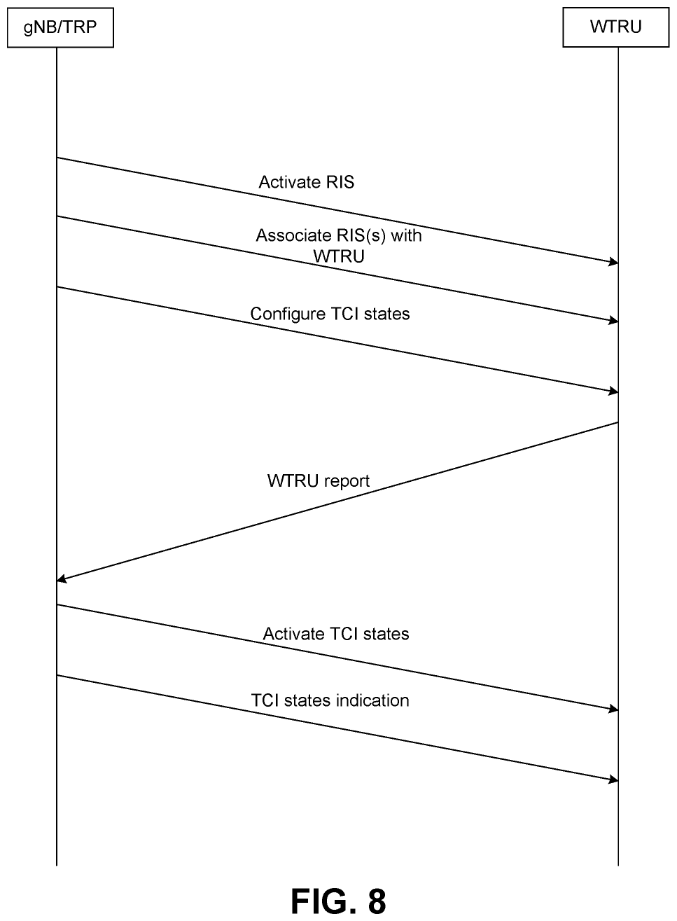

FIG. 8 illustrates an example method of TCI activation and deactivation for an RIS. As illustrated in FIG. 8, a gNB/TRP may activate an RIS. A WTRU may be associated with the RIS. The WTRU may be configured with TCI states for the associated RIS. The WTRU may report measurements. TCI states may be activated for a WTRU. One or more TCI states may be indicated among the activated TCI states.

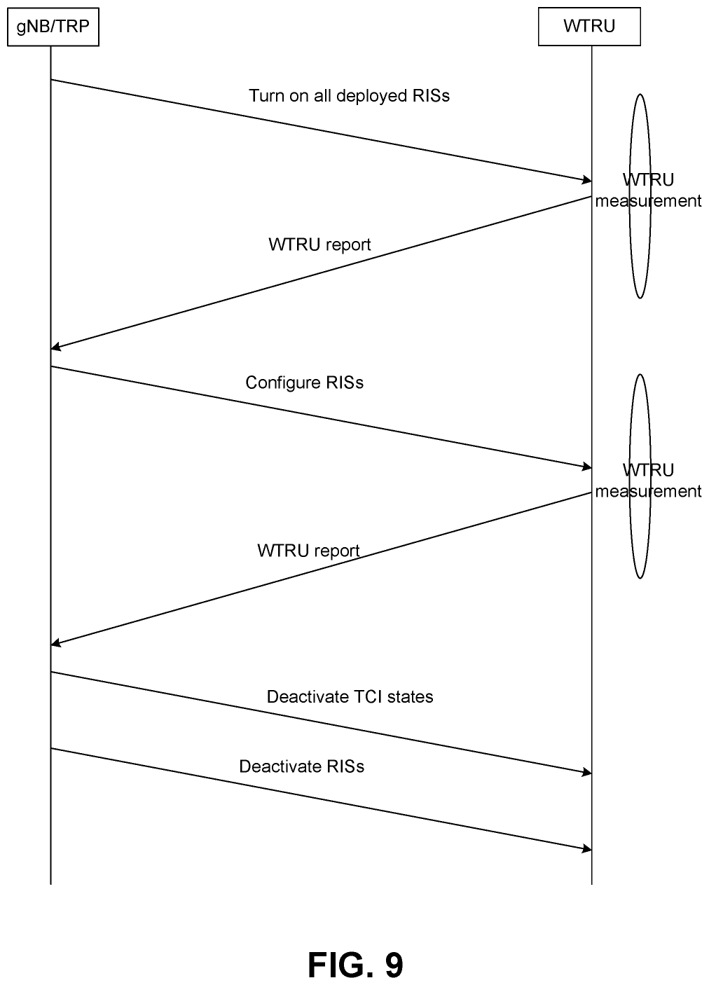

FIG. 9 illustrates an example method of RIS operations for RIS-based or RIS-aided systems. As illustrated in FIG. 9, a gNB/TRP may turn on or activate one or more (e.g., a set or a group of or all) RISs that are deployed in a cell. A WTRU may perform a measurement and send a report to the gNB/TRP. The gNB/TRP may configure an RIS, for example, with an RIS operation mode and/or operating parameters. The WTRU may perform measurement and reporting. One or more (e.g., some) RISs may be deactivated, for example, based on the measurement and report from the WTRU. TCI states may be deactivated for the deactivated RIS. For example, a TCI state may be automatically deactivated if an RIS is deactivated. In some examples, TCI states may be deactivated separately from RIS deactivation.

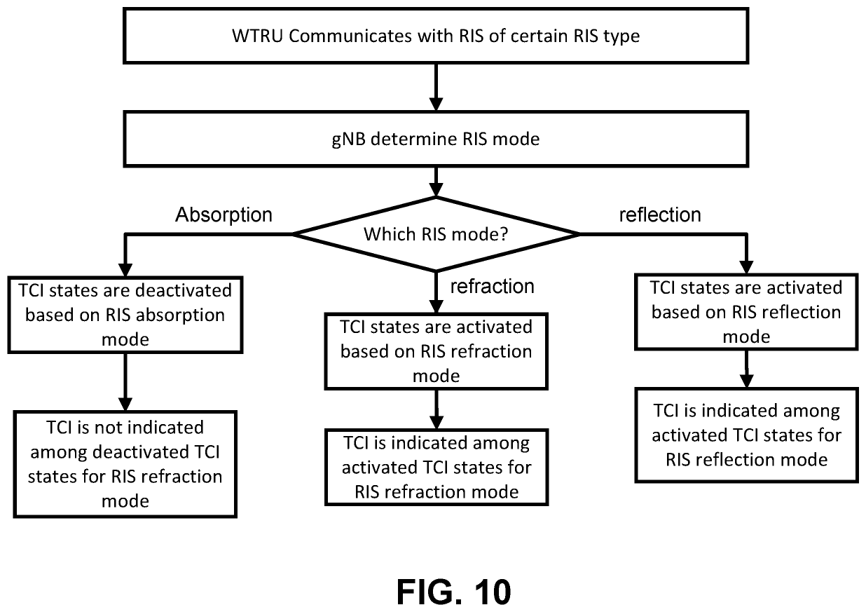

FIG. 10 illustrates an example method of TCI activation and deactivation for RIS-aided systems. As illustrated in FIG. 10, a WTRU may communicate with an RIS of a certain type (e.g., the WTRU may transmit to or receive from an RIS of a certain type). A gNB may determine an RIS operation mode based on an RIS type. TCI states may be activated or deactivated for the WTRU, for example, depending on the RIS operation mode. The WTRU may engage in autonomous WTRU activation/deactivation. The WTRU may activate or deactivate TCI states, for example, based on an indicated RIS operation mode. TCI states may be activated for the WTRU, for example, if the determined RIS operation mode is an RIS reflection mode. TCI states may be activated for the WTRU, for example, if the determined RIS operation mode is an RIS refraction mode. TCI states may be deactivated for the WTRU, for example, if the determined RIS operation mode is an RIS absorption mode.

TCI states for a WTRU may be activated for a (e.g., each) active RIS that is associated with the WTRU. In some examples, there may be many TCIs states being activated. A certain (e.g., determined, selected, (pre) configured, indicated) number of TCI states (e.g., eight TCI states) may be activated, for example, if there is not an RIS associated with a WTRU. A larger number of TCI states (e.g., 16 TCI states) may be activated, for example, if an (e.g., one) active RIS is associated with the WTRU. A larger number of TCI states (e.g., 24 TCI states) may be activated, for example, if multiple (e.g., two) active RISs are associated with the WTRU. The number of activated TCI states may increase as the number of associated activated RISs increases.

A large payload may be used in a MAC CE for control (e.g., if non-unified TCI is used), for example, for a large number of activated TCI states. A MAC CE payload may be used, for example, for activating TCI states for a control channel, such as a PDCCH or a PUCCH. An increased payload size for TCI activation may (e.g., also) result in a higher overhead in a DCI for a TCI indication.

In some examples, there may not be any RISs (e.g., in a cell) associated with a WTRU. In some examples, a larger number of TCI states may be configured (e.g., up to 64 configured TCI states). A larger number of TCI states may be configured, for example, if a (e.g., one) active RIS is associated with a WTRU (e.g., up to 128 configured TCI states). A larger number of TCI states may be configured, for example, if multiple (e.g., two) active RISs are associated with the WTRU (e.g., up to 192 configured TCI states). The number of configured TCI states may increase as the number of associated activated RISs increases.

A TCI indication and/or update may be provided for RIS-based and RIS-aided systems. A WTRU may (e.g., be able to) receive a PDSCH from a gNB and/or an RIS (e.g., in an RIS-aided system). A TCI state may be indicated to a WTRU to receive a PDSCH from a gNB, for example, if beam quality (e.g., based on L1-RSRP, L1-SINR) from gNB is above a (pre) configured threshold. A TCI state may (e.g., also) be indicated to a WTRU to receive PDSCH from RIS, for example, if beam quality from a gNB is below the (pre) configured threshold, or if the beam from gNB is blocked and beam quality from the RIS is above the (pre) configured threshold. TCI states may be indicated to a WTRU to receive a PDSCH from a gNB and an RIS (e.g., to achieve diversity gain for the PDSCH), for example, if beam qualities from the gNB and RIS are above the (pre) configured threshold. TCI state(s) may be indicated to a WTRU, for example, via a DCI carried in a PDCCH. Beam quality may be based on L1-RSRP, L1-SINR, or the like.

A WTRU may (e.g., be able to) transmit a PUSCH to a gNB and/or an RIS. A TCI state may be indicated to a WTRU to transmit a PUSCH to a gNB, for example, if beam quality for the gNB is above a (pre) configured threshold. A TCI state may (e.g., also) be indicated to a WTRU to transmit the PUSCH to an RIS, for example, if beam quality for a gNB is below the (pre) configured threshold, or if a beam to the gNB is blocked and beam quality for the RIS is above the (pre) configured threshold. TCI states may be indicated to a WTRU to transmit a PUSCH to a gNB and an RIS (e.g., to achieve diversity gain for the PUSCH), for example, if beam qualities for the gNB and RIS are above the (pre) configured threshold. TCI state(s) may be indicated to a WTRU, for example, via a DCI carried in a PDCCH.

A WTRU may (e.g., be able to) receive a PDCCH from a gNB and/or an RIS. TCI state(s) may be indicated to the WTRU (e.g., via a MAC CE). TCI state(s) may be indicated to a WTRU to receive a PDCCH from a gNB, for example, if beam quality from the gNB is above a (pre) configured threshold. TCI state(s) may (e.g., also) be indicated to the WTRU to receive a PDCCH from an RIS, for example, if beam quality from the gNB is below the (pre) configured threshold, or if a beam from the gNB is blocked and beam quality from the RIS is above the (pre) configured threshold. TCI states may be indicated to a WTRU to receive a PDCCH from a gNB and an RIS (e.g., to achieve diversity gain for the PDCCH), for example, if beam qualities from the gNB and RIS are above the (pre) configured threshold.

A WTRU may (e.g., be able to) transmit a PUCCH to a gNB and/or an RIS. TCI state(s) may be indicated to a WTRU (e.g., via a MAC CE). TCI state(s) may be indicated to a WTRU to transmit a PUUCH to a gNB, for example, if beam quality for the gNB is above a (pre) configured threshold. TCI state(s) may also be indicated to a WTRU to transmit a PUCCH to an RIS, for example, if beam quality for the gNB is below the (pre) configured threshold, or if the beam to the gNB is blocked and beam quality for the RIS is above the (pre) configured threshold. TCI states may be indicated to a WTRU to transmit PUCCH to a gNB and an RIS (e.g., to achieve diversity gain for the PUCCH), for example, if beam qualities for the gNB and RIS are above the (pre) configured threshold.

A WTRU may indicate a TCI state to a gNB/TRP among activated TCI states for an RIS (e.g., based on a WTRU measurement) to receive a PDSCH from the RIS. A WTRU may indicate a TCI state to a gNB/TRP among activated TCI states for an RIS (e.g., based on a WTRU measurement) to receive a PDCCH, or other DL signal or channel from the RIS, or to transmit a PUCCH, PUSCH, sounding reference signal (SRS) or other UL signal or channel. A WTRU may indicate a TCI state to a gNB/TRP, for example, using a PUCCH, PUSCH, MAC CE, or the like.

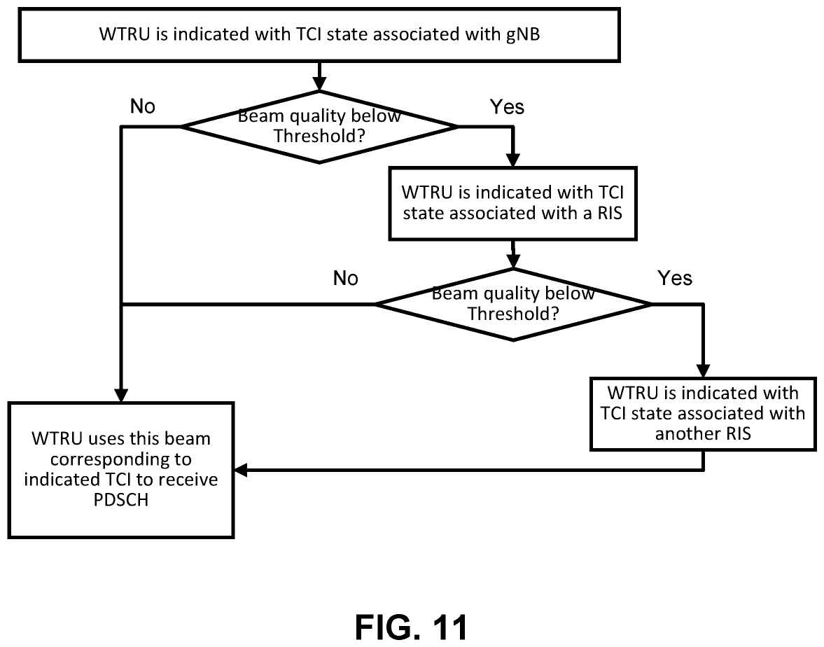

FIG. 11 illustrates an example method of indicating and updating a TCI for an RIS-aided system. As illustrated in FIG. 11, a WTRU may receive an indication of a TCI state that is associated with a gNB. The WTRU may receive an indication of a TCI state that is associated with the gNB, for example, if beam quality is above a (pre) configured threshold. The WTRU may receive an indication of a TCI state that is associated with an RIS, for example, if beam quality is below a (pre-) configured threshold. The WTRU may receive an indication of a TCI state that is associated with the RIS, for example, if beam quality is above a (pre) configured threshold. The WTRU may receive an indication of a TCI state that is associated with another RIS, for example, if beam quality is below a (pre) configured threshold. The WTRU may use the reference signal (beam) corresponding to the indicated TCI state to receive a PDSCH in an RIS-aided system.

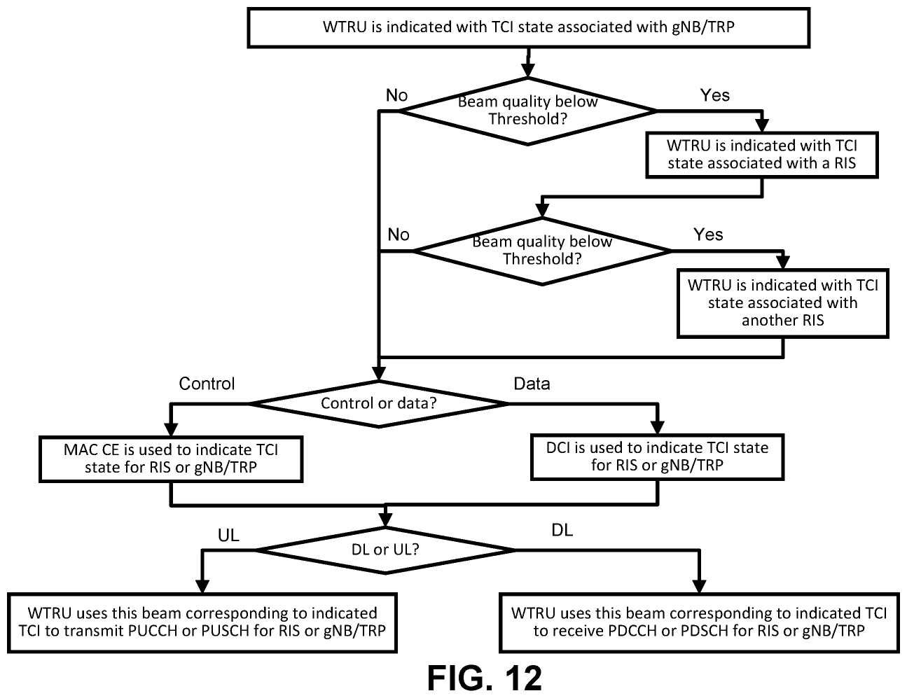

FIG. 12 illustrates an example method of TCI indication and update for an RIS-aided system. As illustrated in FIG. 12, a WTRU may receive an indication of TCI state that is associated with a gNB/TRP. The WTRU may receive an indication of a TCI state that is associated with the gNB/TRP, for example, if beam quality is above a threshold. The WTRU may receive an indication of a TCI state that is associated with an RIS, for example, if beam quality is below a threshold for the gNB/TRP. The WTRU may receive an indication of a TCI state that is associated with the RIS, for example, if beam quality is above a threshold for the RIS. The WTRU may receive an indication of a TCI state that is associated with another RIS, for example, if beam quality is below a threshold for the RIS.

A WTRU may receive different indications, for example, depending on control or data. For example, a WTRU may receive an indication (e.g., for data) of a TCI via a DCI for an RIS-aided system. A WTRU may receive an indication (e.g., for control) of a TCI via an MAC CE for an RIS-aided system. A WTRU may perform transmission or reception (e.g., depending on downlink or uplink, respectively) for an RIS-aided system. A WTRU may perform (e.g., for downlink) a PDCCH or PDSCH reception using a beam indicated in a TCI state for an RIS-aided system. A WTRU may perform (e.g., for uplink) a PUCCH or PUSCH transmission using a beam indicated in a TCI state for an RIS-aided system.

TCI states may be based on reflecting and transmitting beams, for example, for an RIS performing simultaneous reflection and transmission. In an example, there may be four beams for reflecting and another four beams for transmitting. TCI states may be defined jointly, for example, if reflecting beams and transmitting beams are coupled. Table 2 shows an example of TCI states for joint reflecting and transmitting beams. TCI states may (e.g., also) be defined for reflecting and transmitting beams, for example, if reflecting beams and transmitting beams are not coupled. Table 3 shows an example of TCI states for decoupled reflecting beams and transmitting beams.

TABLE 2
Example of TCI states for joint reflecting and transmitting beams

| TCI states | Reflecting beam | Transmitting beam |
|---|---|---|
| 1 | 1 | 1 |
| 2 | 2 | 2 |
| 3 | 3 | 3 |
| 4 | 4 | 4 |

TABLE 3
Example of TCI states for decoupled
reflecting and transmitting beams

| TCI states | Reflecting beam | Transmitting beam |
|---|---|---|
| 1 | 1 | 1 |
| 2 | 2 | 1 |
| 3 | 3 | 1 |
| 4 | 4 | 1 |
| 5 | 1 | 2 |
| 6 | 2 | 2 |
| 7 | 3 | 2 |
| 8 | 4 | 2 |
| 9 | 1 | 3 |
| 10 | 2 | 3 |
| 11 | 3 | 3 |
| 12 | 4 | 3 |
| 13 | 1 | 4 |
| 14 | 2 | 4 |
| 15 | 3 | 4 |
| 16 | 4 | 4 |

TCI states may be defined (e.g., separately) for reflecting beams and transmitting beams. Table 4 shows an example of TCI states for reflecting beams. Table 5 shows an example of TCI states for transmitting beams. A TCI codepoint may be defined for a (e.g., each) TCI state and/or joint TCI states. Table 6 shows an example of TCI codepoints for joint TCI states of reflecting beams and transmitting beams.

Beam sweeping and beam management may be supported (e.g., implemented) for multiple/different RIS operation modes and DL and UL transmission and/or reception using an RIS in an RIS-aided system.

TABLE 4
Example of TCI states for reflecting beams

| TCI states | Reflecting beam |
|---|---|
| 1 | 1 |
| 2 | 2 |
| 3 | 3 |
| 4 | 4 |

TABLE 5
Example of TCI states for transmitting beams

| TCI states | Transmitting beam |
|---|---|
| 5 | 1 |
| 6 | 2 |
| 7 | 3 |
| 8 | 4 |

TABLE 6
Example of TCI codepoints

| | TCI state for | TCI state for |
|---|---|---|
| TCI codepoint | reflecting beam | transmitting beam |
| 1 | 1 | 1 |
| 2 | 1 | 2 |
| 3 | 1 | 3 |
| 4 | 1 | 4 |
| 5 | 2 | 1 |
| 6 | 2 | 2 |
| 7 | 2 | 3 |
| 8 | 2 | 4 |
| 9 | 3 | 1 |
| 10 | 3 | 2 |
| 11 | 3 | 3 |
| 12 | 3 | 4 |
| 13 | 4 | 1 |
| 14 | 4 | 2 |
| 15 | 4 | 3 |
| 16 | 4 | 4 |

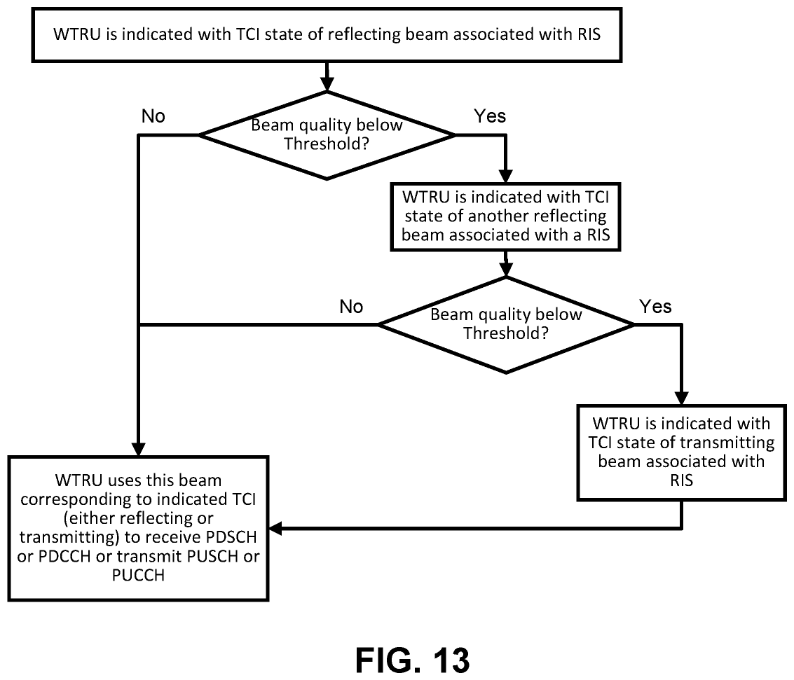

FIG. 13 illustrates an example method of TCI indication and update for an RIS-aided system (e.g., with simultaneous reflecting and transmitting). A WTRU may receive an indication of a TCI state of a reflecting beam that is associated with an RIS. The WTRU may receive an indication of a TCI state of another reflecting beam that is associated with the same or different RIS, for example, if beam quality (e.g., for a source reference signal) is below a (pre) configured threshold. The WTRU may receive an indication of a TCI state of a transmitting beam that is associated with the same or different RIS, for example, if beam quality is below a (pre) configured threshold. A WTRU may use the beam corresponding to the indicated TCI state for a reflecting beam and/or a transmitting beam to receive a PDSCH or PDCCH, to transmit a PUSCH or PUCCH, and/or the like. Beam quality may be based on measurement of a source reference signal.

A large payload may be used in a MAC CE for control (e.g., control information or control signaling). For example, a large payload may be used in a MAC CE for control signaling if (e.g., only if) a non-unified TCI is used (e.g., for a large number of configured or activated TCI states). A large payload may be used in a MAC CE for control signaling and/or data, for example, if a unified TCI is used. A large payload may be used in a DCI for data. For example, a large payload may be used in a DCI for data if (e.g., only if) a non-unified TCI is used. A large payload may be used in a DCI for control signaling and/or data, for example, if a unified TCI is used. A large payload may be used for a TCI state for control signaling, such as a PDCCH reception or a PUCCH transmission for an RIS-aided system. A large payload may be used for a TCI state for data, such as a PDSCH reception or a PUSCH transmission for an RIS-aided system.

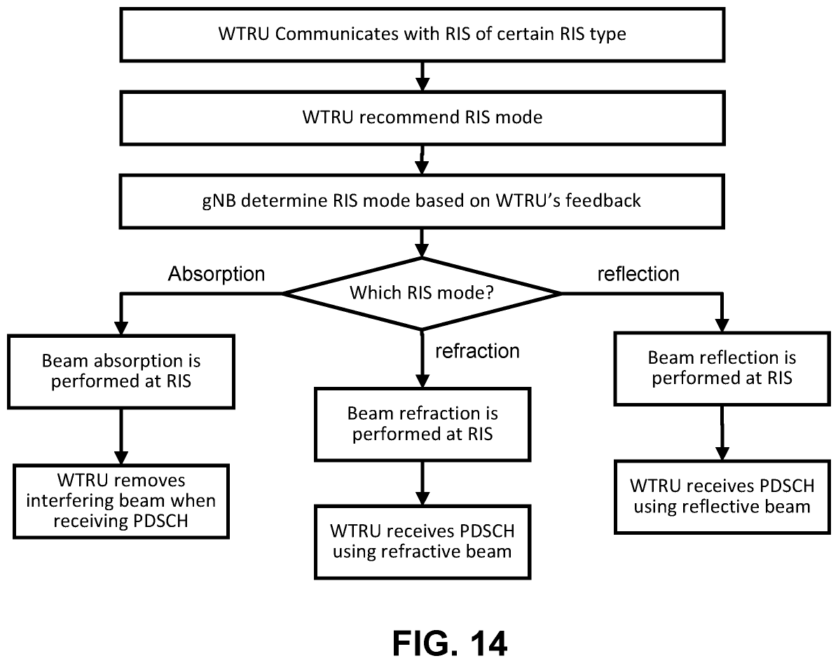

FIG. 14 illustrates an example method of a PDSCH reception at a WTRU for an RIS type and an RIS mode based on the WTRU's feedback. As illustrated in FIG. 14, a WTRU may communicate with an RIS of a certain (e.g., determined, selected, indicated) type. The WTRU may recommend an RIS mode (e.g., of operation). A gNB may determine an RIS mode based on the WTRU's feedback. The gNB may determine and indicate an RIS mode that is different from the recommended RIS mode. Beam reflection may be performed at the RIS, for example, if the recommended RIS mode is a reflection mode. The WTRU may receive a PDSCH using a reflective beam from the RIS. Beam refraction may be performed at the RIS, for example, if the recommended RIS mode is a refraction mode. The WTRU may receive a PDSCH using a refractive beam from the RIS. Beam absorption may be performed at the RIS, for example, if the recommended RIS mode is an absorption mode. The WTRU may remove the interfering beam, for example, if/when receiving a PDSCH.

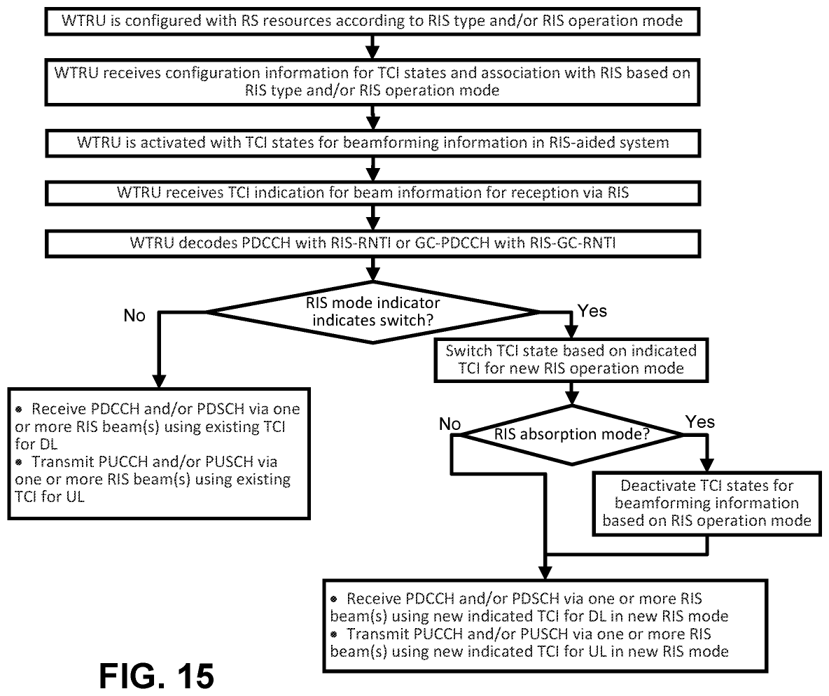

FIG. 15 illustrates an example method of RIS mode switching and TCI indication. As illustrated in FIG. 15, a WTRU may perform a PDCCH/PDSCH reception and/or a PUCCH/PUSCH transmission via an RIS for an RIS-aided system based on an RIS type and/or an RIS operation mode. The WTRU may be configured with RS resources, for example, according to an RIS type and/or an RIS operation mode. The WTRU may perform, for example, one or more of the following: receive configuration information with TCI states and/or an association with an RIS based on an RIS type and/or an RIS operation mode; activate TCI states for beamforming information in an RIS-aided system (e.g., based on the RIS operation mode); receive a TCI indication for beam information for reception or transmission via the RIS; decode a PDCCH with an RIS-RNTI or a GC-PDCCH with an RIS-GC-RNTI; receive an indication of an RIS operation mode change or switch; switch the TCI state based on the indicated TCI for the new RIS operation mode (e.g., the TCI may be indicated with a mode indication, such as via PDCCH, GC-PDCCH, and/or the TCI may not be indicated or updated if the RIS mode is not changed); deactivate one or more TCI states for beamforming information corresponding to an absorption operation based on an RIS absorption mode (e.g., on a condition that the RIS operation mode is absorption mode, deactivate TCI state(s) associated with other RIS operation mode(s)); receive a PDCCH and/or a PDSCH via one or more RIS beam(s) using the newly indicated DL TCI associated with the new RIS mode; transmit a PUCCH and/or a PUSCH via one or more RIS beam(s) using the newly indicated UL TCI associated with the new RIS mode; receive a PDCCH and/or a PDSCH via one or more RIS beam(s) using the existing DL TCI, for example, if the RIS mode is not changed; and/or transmit a PUCCH and/or a PUSCH via one or more RIS beam(s) using the existing UL TCI for the existing RIS mode, for example, if the RIS mode is not changed.

RIS on/off information may be provided for efficient interference management for RIS-based or RIS-aided systems. An RIS may be (e.g., dynamically) turned ON or OFF, for example, by using a group common PDCCH (GC-PDCCH) to control when the RIS is ON (e.g., operation enabled) and OFF (e.g., operation disabled). On/off information may be indicated using the same RNTI and different PDCCH monitoring periodicities or windows for a GC-PDCCH. Different RNTIs may be used with the same PDCCH monitoring periodicity and window. An RIS may be partitioned into multiple groups. RIS on/off information may be applied for different RIS groups. A bitmap for on/off information may be used for each RIS group. A different bitmap size may be used, for example, depending on a group size.

An RIS (e.g., or an RIS controller) may decode a GC-PDCCH and/or read a DCI carried in the GC-PDCCH. A WTRU may obtain the control field (e.g., bitmap), which may indicate an (e.g., each) RIS state in the group (e.g., whether the RIS is ON or OFF). A gNB may configure an RIS group ID. A gNB may configure an RIS ID for an (e.g., each individual) RIS in an (e.g., each) RIS group. An RIS group ID may be masked with a GC-PDCCH. An RIS may decode a GC-PDCCH, for example, based on a CRC masked with an RIS group ID. An RIS may read the RIS ID and/or an associated on/off indicator, for example, if/when the RIS obtains the control field of the RIS on/off indicator in the DCI. The RIS may be turned ON, for example, if RIS “on” is indicated in RIS on/off indicator. The RIS may be turned OFF, for example, if RIS “off” is indicated in the RIS on/off indicator. PDCCH monitoring may be supported during an off period, for example, to decode and read the RIS on/off indicator during the RIS off period.

A MAC CE may be used, for example, to accommodate a larger number of RISs. A GC-PDCCH may not be efficient, for example, if a payload size is large. A MAC CE may be used to carry an RIS on/off indicator. A MAC CE may be triggered to indicate an RIS on/off state, for example, if the RIS group size is larger than a (pre) configured threshold. A GC-PDCCH may be triggered to indicate an RIS on/off state, for example, if the RIS group size is not larger than a (pre) configured threshold.

RRC signaling may be used for slow changing of an RIS on/off state. A GC-PDCCH may be used, for example, based on interference conditions. For example, a GC-PDCCH may be used if an interference condition changes quickly. RRC signaling may be used, for example, if an interference condition changes slowly. A MAC CE may be used, for example, to balance payload size and speed of RIS control. An RIS/RIS controller may act (e.g., behave) as a WTRU in control signaling protocols/procedures.

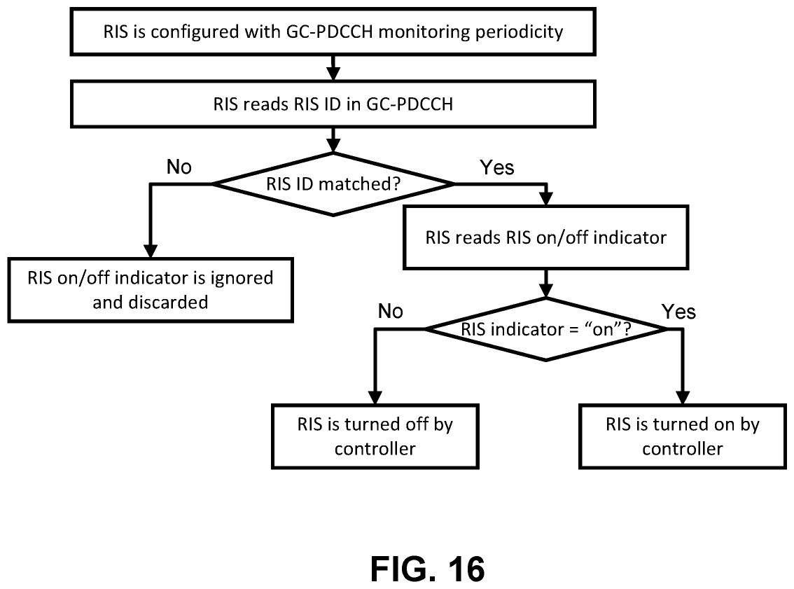

FIG. 16 illustrates an example method of RIS on/off information for efficient interference management. As illustrated in FIG. 16, an RIS may be configured with a GC-PDCCH monitoring period. The RIS may read an RIS ID in a DCI carried in a GC-PDCCH. The RIS may continue to read the RIS on/off indicator in the DCI, for example, if the decoded RIS ID matches the RIS's own RIS ID. The RIS may be turned ON if the RIS indicator is “on.” The RIS may be turned OFF if the RIS indicator is “off.” The RIS may stop reading the RIS on/off indicator in the DCI, for example, if the decoded RIS ID does not match the RIS's own RIS ID. The RIS may ignore the RIS on/off indicator and/or discard the control information (e.g., if the decoded RIS ID does not match the RIS's own RIS ID).

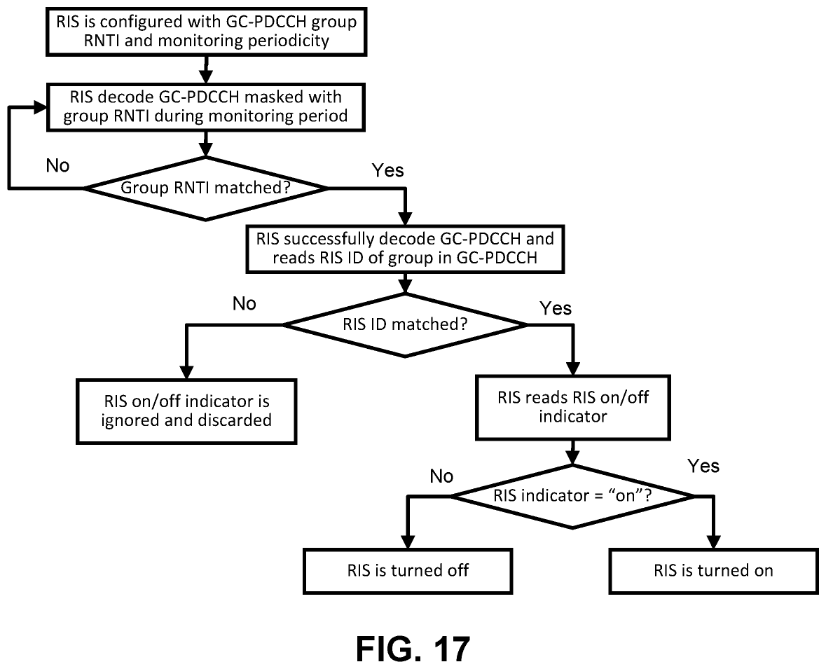

FIG. 17 illustrates an example method of RIS on/off indication via a group RNTI. As illustrated in FIG. 17, an RIS may be configured with a group RNTI and GC-PDCCH monitoring period. The RIS may decode the GC-PDCCH masked with group RNTI during a (e.g., configured) monitoring period. The RIS may (e.g., successfully) decode the GC-PDCCH, for example, if the group RNTI matches. The RIS may read the RIS ID of the group in a DCI carried in the GC-PDCCH. The RIS may continue to read the RIS on/off indicator in the DCI, for example, if the decoded RIS ID matches the RIS's own RIS ID in the group. The RIS may be turned ON if the RIS indicator is “on.” The RIS may be turned OFF if the RIS indicator is “off.” The RIS may stop reading the RIS on/off indicator in the DCI, for example, if the decoded RIS ID does not match the RIS's own RIS ID in the group. The RIS may ignore the RIS on/off indicator and/or discard the control information (e.g., if the decoded RIS ID does not match the RIS's own RIS ID).

Signaling of an on/off pattern may (e.g., also) be used. An RIS may be ON during certain symbols, or slots, etc., which may be valid, for example, during a time period or until a next indication and/or reconfiguration.

An NW may turn on an RIS (e.g., put the RIS in an ON mode) based on an interference measurement. For example, an NW may turn on an RIS based on an interference measurement report from WTRU(s). A WTRU may report an interference measurement and an indication of the RIS contributing to the interference. The WTRU may report one or more interfering RISs to the NW. The WTRU may report an RIS as an interfering RIS, for example, if an interference level is high (e.g., if interference is above a (pre) configured threshold). A WTRU may recommend whether to turn an RIS ON or OFF, for example, based on an interference measurement. An RIS may be turned OFF, for example, based on an interference level (e.g., if interference is above a (pre) configured threshold). An RIS may be turned ON (e.g., left ON), for example, if interference is below a (pre) configured threshold.

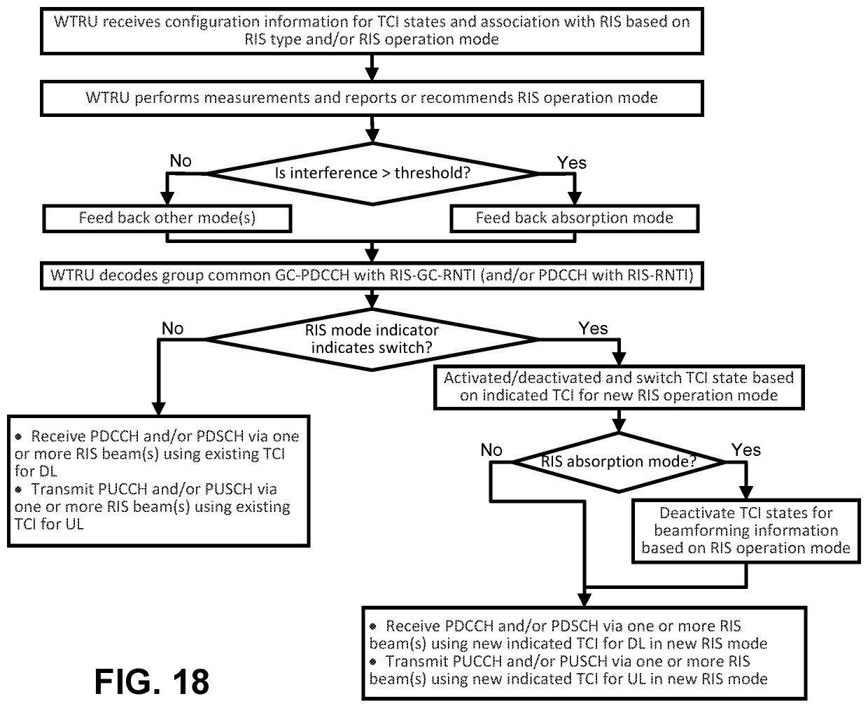

An RIS operation mode may be switched or changed, for example, based on an interference measurement (e.g., as described with respect to FIG. 18). For example, an RIS operation mode may be switched or changed based on an interference measurement report (e.g., a report indicating an interference level associated with the RIS and/or an interference level associated with a gNB) from one or more WTRUs. A WTRU may perform, for example, one or more of the following: measure interference on primary RS resources for a gNB/transmission-reception point (TRP) in an RIS-aided system; measure interference on secondary RS resources for associated RIS(s) in the RIS-aided system. An RIS operation mode may be switched or changed to an absorption mode from a reflection mode, for example, if an interference level arising from the RIS is high (e.g., beam quality is above a threshold). An RIS operation mode may be switched or changed to a reflection mode or a transmitting mode, for example, if an interference level arising from the RIS is low (e.g., beam quality is below a threshold). Beam quality may be measured, for example, by an L1-RSRP, L1-SINR, or the like.

FIG. 18 illustrates an example method of RIS mode switching and TCI indication based on an interference level. As illustrated in FIG. 18, a WTRU may receive configuration information with TCI states and/or an association with an RIS based on an RIS type and/or an RIS operation mode. The WTRU may perform measurements (e.g., reference signal measurement(s) and/or interference measurement(s) and report/recommend an RIS operation mode (e.g., to a network node, for example, a gNB). The WTRU may determine (e.g., based on the measurements) whether an interference level is above a (pre) configured threshold (e.g., an interference threshold). If the interference level is above the threshold (e.g., greater than the threshold), the WTRU may feedback (e.g., report/recommend) absorption mode (e.g., RIS absorption mode). If the interference is not above the threshold (e.g., below the threshold or less than the threshold), the WTRU may feedback (e.g., report/recommend) one or more other mode(s) (e.g., other than absorption mode). The WTRU may decode a PDCCH with an RIS-RNTI or a GC-PDCCH with an RIS-GC-RNTI. The WTRU may receive an indication of an RIS operation mode change or switch. If the WTRU receives the indication of the RIS operation mode switch, the WTRU may switch the TCI state (activate/deactivate one or more TCI states) based on the indicated TCI for the new RIS operation mode (e.g., the TCI may be indicated with a mode indication, such as via PDCCH, GC-PDCCH, and/or the TCI may not be indicated or updated if the RIS mode is not changed). If the indicated TCI state corresponds to RIS absorption mode, the WTRU may deactivate one or more TCI states for beamforming information. The WTRU may receive a PDCCH and/or a PDSCH via one or more RIS beam(s) using the newly indicated DL TCI associated with the new RIS mode. The WTRU may transmit a PUCCH and/or a PUSCH via one or more RIS beam(s) using the newly indicated UL TCI associated with the new RIS mode. If the RIS mode is not changed (e.g., the RIS mode indicator does not indicate a switch), the WTRU may receive a PDCCH and/or a PDSCH via one or more RIS beam(s) using the existing DL TCI and/or transmit a PUCCH and/or a PUSCH via one or more RIS beam(s) using the existing UL TCI for the existing RIS mode.

A device (e.g., a wireless transmit/receive unit (WTRU) may receive a first physical downlink shared channel (PDSCH) transmission using a first transmission configuration indicator (TCI) state associated with a base station and using a second TCI state associated with a first reconfigurable intelligent surface (RIS) mode. The device may perform a reference signal measurement associated with the base station and an RIS. The device may determine an interference level based on the reference signal measurement. The device may determine a second RIS mode based on the interference level. The device may send a message to the base station. The message may indicate the second RIS mode. The device may receive an indication of a third RIS mode associated with a third TCI state. The third TCI state may be associated with the base station. The device may receive a second PDSCH transmission using the third TCI state.

On a condition that the interference level is greater than an interference threshold, the second RIS mode may be determined to be an absorption mode. On a condition that the third RIS mode indicates an absorption mode, the device may deactivate the second TCI state associated with the first RIS mode. The message may indicate at least one of: the reference signal measurement, or the interference level. The third RIS mode may be different from the second RIS mode. The device may activate the third TCI state based on the indication of the third RIS mode. The device may receive configuration information. The configuration information may indicate a plurality of TCI states and respective associations with RIS operation modes. The indication of the third RIS mode may be received in a group common physical downlink control channel (GC-PDCCH) transmission.

A training phase for an RIS may be introduced. A WTRU may not (e.g., be able to) measure interference from an RIS if the RIS is turned OFF, for example, since the RIS may not function when it is turned OFF. A training phase may be introduced for an interference measurement. An RIS may be turned ON, for example, periodically or aperiodically. A CSI-RS resource may be configured for interference measurements, for example, according to when an RIS is turned ON. In an example of an RIS turned ON periodically, the RIS may be ON for a (pre) configured window or duration for an interference measurement and may be turned OFF (e.g., autonomously) after a measurement period. RIS on/off states may be based on timer.

In an example of an RIS being turned ON aperiodically, an RIS may be triggered (e.g., by a DCI or a MAC CE) to turn ON. A (pre) configured window or duration may be used for an interference measurement and/or a channel measurement. A window or duration may be indicated, for example, in a DCI or a MAC CE. A WTRU may perform an interference measurement, for example, based on an indicated window or duration. The window or duration may be indicated, for example, in a triggering signal during a triggering phase. A WTRU may perform an interference measurement based on a (pre) configured window or duration, for example, if a window or duration is not indicated (e.g., in a triggering signal during triggering phase). A window or duration that is indicated (e.g., in a triggering signal during a triggering phase) may override a window or duration that is configured or preconfigured.

An RIS controller may be turned OFF. A WTRU may perform interference measurements, for example, if some functionality is allowed when an RIS is turned OFF and/or partially turned OFF. For example, an RIS controller may be turned OFF while an RIS reflector may not be turned OFF. An RIS that is partially OFF may reflect a signal, for example, according to a default setting that may not be able to adjusted or updated if the RIS controller is turned OFF. An RIS operation mode and functionality may be turned OFF. An RIS may receive signaling from a gNB and respond by turning ON an operation mode and functionality, for example, if an “on” indicator is received.

A RIS may be turned ON or OFF at different levels. The RIS may be partially or fully turned ON or OFF at different states. The RIS may have some functionalities turned ON, and/or may have other functionalities turned OFF. The RIS may be turned ON in some operation mode(s) and/or may be turned OFF in other operation mode(s). The RIS may have a reception mode turned ON, and/or may have a transmission mode turned OFF, or vice versa. The RIS may be turned ON for signal or beam reflection and/or may be turned off for signal or beam refraction, or vice versa. The RIS may be turned ON for signal or beam transmission, and/or may be turned OFF for signal or beam reflection or refraction, or vice versa. Some portion(s) of the RIS may be turned ON and other portion(s) of RIS may be turned OFF. How the RIS is turned ON or OFF may be determined based on an indication received from a gNB/TRP. How the RIS is turned ON or OFF may be determined based on a WTRU's feedback. The RIS may autonomously turn itself ON or OFF. The RIS may autonomously turn itself ON or OFF based on some condition(s), measurement(s), or criteria.

Mixed RIS types may be deployed in a (e.g., the same) system. A WTRU may be configured with CSI-RS resources or resource sets for interference management. A WTRU may be configured with RIS types. A WTRU may be configured with an association between RIS types and/or RS resources or resource sets. RS resources or resource sets may be CSI-RS resources or resource sets, SSB resources or resource sets, or the like. CSI-RS resources or resource sets may be ZP-CSI-RS resources or resource sets, NZP-CSI-RS resources or resource sets, CSI interference measurement (CSI-IM) resources or resource sets, or the like. Different RIS operation may cause different degrees of interference. Interference may become more dynamic, for example, if/when different RIS operations coexist in the same system. Interference management (IM), measurement and/or reporting may be implemented.

Beam direction may be changed in the same operation mode, for example, to steer an interference beam away from a WTRU. An operation mode may be changed/switched from one operation mode to another operation mode, for example, to mitigate interference. For example, an RIS may be switched from reflection mode to absorption mode. A WTRU may report interference to a gNB/TRP. A WTRU may recommend an RIS operation mode to a gNB. A WTRU may report interference (e.g., with a recommended mode) corresponding to the CSI-RS, for example, if/when the WTRU measures CSI-RS (e.g., for IM or the like).

Uplink/downlink (UL/DL) TDD configurations may be provided for RIS-aided systems. In some examples, an RIS may use (e.g., need) a specific UL/DL TDD configuration. A configuration may depend on the RIS type (e.g., active, semi-active, or passive).

A (e.g., each) WTRU with a link to a gNB via an RIS may be configured with (e.g., only) a cell-specific UL/DL TDD configuration (e.g., via tdd-UL-DL-ConfigurationCommon). The same UL/DL TDD configuration may be used for an RIS link (e.g., RIS-to-gNB link) independent of RIS type, for example, if (e.g., all) WTRUs connected via an RIS have the same slot configuration for UL/DL transmission.

A (e.g., each) WTRU with a link to a gNB via an RIS may be configured with a cell-specific UL/DL TDD configuration (e.g., via tdd-UL-DL-ConfigurationCommon) and/or a WTRU-specific UL/DL TDD configuration (e.g., via tdd-UL-DL-ConfigurationDedicated). The WTRU-specific UL/DL TDD configuration may be used to modify the flexible (e.g., not dedicated as UL or DL) slots and symbols signaled by tdd-UL-DL-ConfigurationCommon. A WTRU-specific UL/DL TDD configuration may be used for an RIS (e.g., an RIS-to-gNB link) to accommodate a WTRU-specific UL/DL TDD configuration, for example, if WTRUs connected via RIS have a different slot configuration for UL/DL transmissions.

A gNB may configure a UL/DL TDD configuration for an RIS where the same UL/DL assignment for flexible slots/symbols may be used for (e.g., all) WTRUs with a link to a gNB via an RIS (e.g., symbols=allDownlink or symbols=allUplink or the same nrofDownlinkSymbols and nrofUplinkSymbols may be in the slot if symbols=explicit in tdd-UL-DL-ConfigurationDedicated).

A gNB may configure a UL/DL TDD configuration for an RIS, for example, using several UL/DL patterns (e.g., in addition to a mandatory pattern, pattern1, and/or an optional pattern, pattern2, if needed). The patterns may have the same (e.g., or similar) parameters, such as one or more of the following: transmission periodicity, total number of slots, number of downlink and uplink slots, and/or number of downlink and uplink symbols. The parameters of a (e.g., each) pattern may have the same or different values as parameters of another pattern. The number of patterns used for an RIS to accommodate a WTRU-specific UL/DL TDD configuration may be decided, for example, based on the number of WTRUs with a link to a gNB via an RIS and/or based on the transmission periodicity of a (e.g., each) pattern. In some examples, the sum of the periodicity of each pattern (P1+P2+ . . . +PN) may be divided by a time (e.g., 20 ms) (e.g., to have the first symbol in a numbered radio frame, for example, an even numbered radio frame). The patterns may be concatenated and/or may repeat (e.g., with the sum of the periodicity of each pattern). An RIS type may be active or semi-active, for example, to reflect or absorb signals for an assigned transmission direction. Transmission signals to/from a WTRU may be absorbed by the RIS, for example, if the slot is assigned for UL/DL, respectively.

An RIS type may be passive. A gNB may have a different WTRU-specific UL/DL TDD configuration. The gNB may be unable to find the same UL/DL assignment for flexible slots/symbols for (e.g., all) WTRUs with a link with the gNB via an RIS. The gNB may determine an option (e.g., the best option) that applies to some (e.g., most) of the WTRUs. The gNB may configure the UL/DL TDD configuration for the RIS. The gNB may not configure the flexible slots for the WTRUs if the configured UL/DL TDD slots do not fit their requirements. The flexible slots may not be used for UL/DL transmission for these WTRUs.

An RIS may not expect tdd-UL-DL-ConfigurationDedicated to indicate a symbol as uplink or as downlink if tdd-UL-DL-ConfigurationCommon indicated that symbol as downlink or as uplink, respectively.

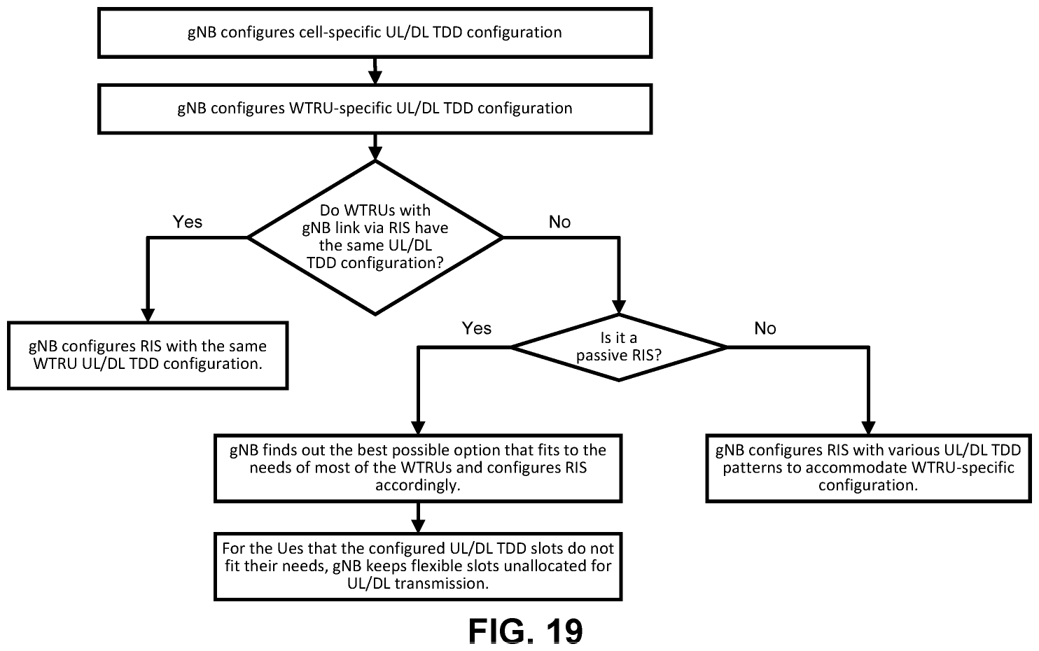

FIG. 19 illustrates an example method of UL/DL TDD configuration for an RIS. An UL/DL TDD configuration for an RIS may to be assigned, for example, based on the similarity of the WTRU-specific UL/DL TDD configuration for WTRUs having a link with a gNB via an RIS and/or an RIS type. An RIS may not absorb signals coming from/to the WTRU/gNB for a UL/DL transmission, for example, if the RIS type is passive. A gNB may determine a TDD configuration option (e.g., the best TDD configuration option) for some (e.g., most) of the WTRUs that are connected via the RIS.

Timing information may be provided to align transmission and reception boundaries for RIS-based or RIS-aided systems. Timing information to align transmissions may be used, for example, depending on the RIS deployment.

Timing information may not be needed, for example, if an RIS is near (e.g., alongside) a gNB. For example, an RIS may be co-located with a gNB to enable an RIS-based massive MIMO transmission.

An RIS may be distant (e.g., located away) from a gNB, for example, to improve communication performance for a set of WTRUs and/or to enhance a coverage area of the gNB. The gNB-to-RIS link may have some delay, for example, if the RIS is located away from the gNB. WTRUs that have a link with the gNB via the RIS (e.g., within a gNB coverage area with or without the RIS) may be affected, for example, due to the delay(s) on the gNB-to-RIS link and/or the WTRU-to-RIS link.

A gNB-to-RIS link (e.g., only a single gNB-to-RIS link) may be considered. A timing advance adjustment for the WTRUs that have a link with the gNB via the RIS may be determined accordingly. The gNB may (e.g., first) estimate the transmission timing alignment for the WTRUs that have a link with the gNB via the RIS. For example, WTRUs may be in gNB coverage without the RIS (e.g., the RIS may be used to enhance communication). The RIS may be used to enhance a gNB's coverage area. Timing information may be developed, for example, by considering one or more of the following: the duplex mode of the cell, the frequency range, the propagation delay of the gNB-to-RIS link, and/or any processing delay on the RIS. For example, a gNB may obtain an RIS processing delay as part of a feedback or capability message from an RIS. A gNB may estimate timing information. The gNB may make use propagation delay information from WTRUs that are in a gNB coverage area (e.g., without the RIS) by comparing a gNB-to-WTRU link (e.g., for WTRU propagation delay) and a gNB-to-RIS/RIS-to-WTRU link to estimate a propagation and processing delay of the RIS.

A gNB may (e.g., during an initial access stage) estimate the propagation delay (e.g., whole path, such as gNB-to-RIS, RIS-to-WTRU). The propagation delay from the RIS to the WTRU may be estimated, for example, if the gNB knows the propagation delay of the gNB to the RIS in advance. The gNB may align a timing advance offset, for example, based on the gNB estimate of a transmission timing alignment for the WTRUs that have a link with the gNB via the RIS. There may be a single link between the gNB and the RIS. The gNB may configure the timing advance offset value, for example, based on the highest delay (e.g., propagation and processing) estimation for the WTRUs that have a link with the gNB.

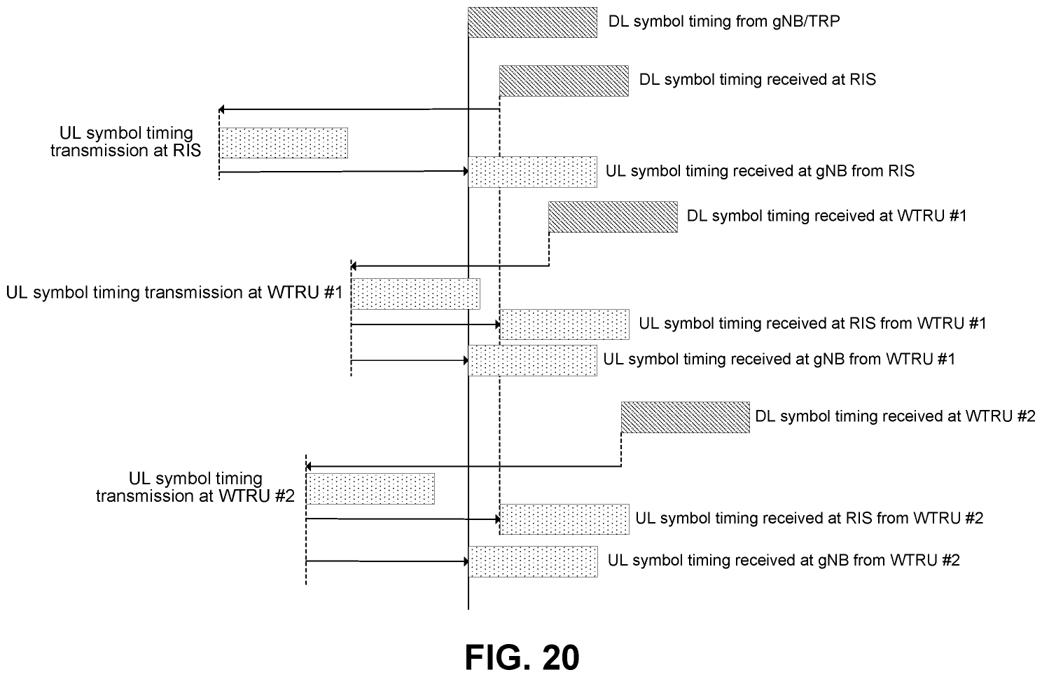

FIG. 20 illustrates an example of timing advance offset alignment for an RIS-aided system. As illustrated in FIG. 20, two WTRUs may be at different locations, each with a link to a gNB via an RIS. The RIS may be located away from the gNB. The gNB may send a timing advance offset, for example, so that the uplink transmissions from the WTRUs reach the RIS and the gNB at the same time.

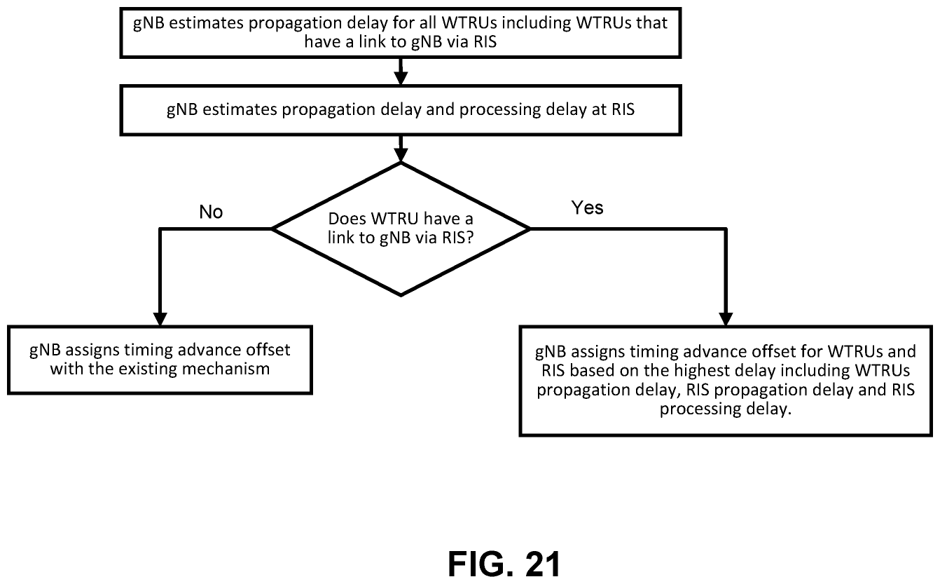

FIG. 21 illustrates an example method of using timing information to align transmission and reception boundaries for an RIS. As illustrated in FIG. 21, a gNB may (e.g., first) estimate the propagation delay of the WTRUs, the propagation delay of the RIS, and the processing delay at the RIS. The gNB may determine whether the WTRUs have a link to the gNB via the RIS. The gNB may (e.g., if the WTRUs have a link to the gNB via the RIS) align the timing advance offset value, for example, based on (e.g., considering) the highest summed delay (e.g., including propagation and processing) to enable the RIS and the gNB to receive the UL symbol timing at the same time.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that-in the case where there is more than one single medium-there is no requirement that any particular part of the code be stored on any particular

1-15. (canceled)

16. A wireless transmit/receive unit (WTRU) comprising:
a processor configured to:
receive a first physical downlink shared channel (PDSCH) transmission using a first transmission configuration indicator (TCI) state associated with a base station and using a second TCI state associated with a first reconfigurable intelligent surface (RIS) mode;
perform a reference signal measurement associated with an RIS;
determine an interference level based on the reference signal measurement;
determine a second RIS mode based on the interference level;
send a message to the base station, wherein the message indicates the second RIS mode;
receive, from the base station, an indication of a third RIS mode
determine a third TCI state based on the third RIS mode, wherein the third TCI state is associated with the base station; and
receive a second PDSCH transmission using the third TCI state.

17. The WTRU of claim 16, wherein on a condition that the interference level is greater than an interference threshold, the second RIS mode is determined to be an absorption mode.

18. The WTRU of claim 16, wherein on a condition that the third RIS mode indicates an absorption mode, deactivate the second TCI state associated with the first RIS mode.

19. The WTRU of claim 16, wherein the message further indicates at least one of: the reference signal measurement, or the interference level.

20. The WTRU of claim 16, wherein the third RIS mode is different from the second RIS mode, and wherein the processor is further configured to activate the third TCI state based on the indication of the third RIS mode.

21. The WTRU of claim 16, wherein the processor is further configured to receive configuration information, and wherein the configuration information indicates a plurality of TCI states and respective associations with RIS operation modes.

22. The WTRU of claim 16, wherein the indication of the third RIS mode is received in a group common physical downlink control channel (GC-PDCCH) transmission.

23. The WTRU of claim 16, wherein the processor being configured to perform the reference signal measurement associated with the RIS comprises the processor being configured to measure a reference signal received from the RIS.

24. A method comprising:
receiving a first physical downlink shared channel (PDSCH) transmission using a first transmission configuration indicator (TCI) state associated with a base station and using a second TCI state associated with a first reconfigurable intelligent surface (RIS) mode;
performing a reference signal measurement associated with an RIS;
determining an interference level based on the reference signal measurement;
determining a second RIS mode based on the interference level;
sending a message to the base station, wherein the message indicates the second RIS mode;
receiving, from the base station, an indication of a third RIS mode
determining a third TCI state based on the third RIS mode, wherein the third TCI state is associated with the base station; and
receiving a second PDSCH transmission using the third TCI state.

25. The method of claim 24, wherein on a condition that the interference level is greater than an interference threshold, the second RIS mode is determined to be an absorption mode.

26. The method of claim 24, wherein on a condition that the third RIS mode indicates an absorption mode, deactivate the second TCI state associated with the first RIS mode.

27. The method of claim 24, wherein the message further indicates at least one of: the reference signal measurement, or the interference level.

28. The method of claim 24, wherein the third RIS mode is different from the second RIS mode, and wherein the method further comprises activating the third TCI state based on the indication of the third RIS mode.

29. The method of claim 24, wherein the method further comprises receiving configuration information, and wherein the configuration information indicates a plurality of TCI states and respective associations with RIS operation modes.

30. The method of claim 24, wherein the indication of the third RIS mode is received in a group common physical downlink control channel (GC-PDCCH) transmission.

31. The method of claim 24, wherein performing the reference signal measurement associated with the RIS comprises measuring a reference signal received from the RIS.
